(19) United States
(12) Patent Application Publication
(10) Pub. No.: US 2024/0376872 A1
(43) Pub. Date: Nov. 14, 2024

(54) SYSTEMS AND METHODS FOR GRAVITY ENERGY STORAGE

(71) Applicant: RENEWELL ENERGY, Houston, TX (US)

(72) Inventors: Stefan James STRECKFUS, Denver, CO (US); Samuel Albert SACKETT, Livingston, TX (US); Zachary WENRICK, Applegate, CA (US); Aaron MUNOZ, San Luis Obispo, CA (US); Anthony Kemp GREGORY, Houston, TX (US)

(73) Assignee: RENEWELL ENERGY, Houston, TX (US)

(21) Appl. No.: 18/659,461

(22) Filed: May 9, 2024

Related U.S. Application Data
(60) Provisional application No. 63/501,014, filed on May 9, 2023.

(51) Int. Cl. F03G 7/00; F03G 3/00

(52) U.S. Cl. CPC F03G 7/027; F03G 3/094

(57) ABSTRACT

Methods and systems for gravity-based energy storage may utilize various controls. For example, a control system for a gravity well may include an active front end controller (AFE) configured to receive a plurality of reference signals and a plurality of target control parameters. The system may include a rate limiter coupled to the AFE controller and configured to adjust a rate of change associated with each of the plurality of target control parameters based, at least in part, on the plurality of reference signals. The system may include a speed control loop coupled to the AFE controller and configured to communicate with a variable-frequency drive (VFD), the VFD configured to store the plurality of target control parameters. The system may include an AFE component coupled to the AFE controller and configured to communicate with a grid based on the plurality of target control parameters.

### FIELD

The present disclosure relates to energy storage, and more specifically to remote and collective control of gravity energy storage resources capable of converting potential energy to electrical energy utilizing wellbores for the generation of energy storage services.

### BACKGROUND

Energy generation from renewable resources accounts for a significant portion of energy utilization. However, renewable resources such as wind and solar power are unreliable for consistent power generation because they rely on resources that are only available at intermittent intervals. Often, wind and solar power sources are unable to produce electricity in lockstep with demand. Accordingly, energy sources such as natural gas power, nuclear power, coal power, and the like remain dominant despite environmental concerns. As a result, there has been growing demand for energy storage technologies to harness renewable and other intermittent energy sources in times of excess production capacity and release the stored energy when there is excess demand or production capacity is low.

Although current techniques for renewable energy storage, such as battery-based and supercapacitor techniques, are based on technological advancements made over many years, current renewable energy storage technology may still be expensive, particularly when employed for storage of massive amounts of electricity. For example, pumped-storage hydroelectricity (“Pumped Hydro”) has been shown to be effective, but may still be expensive and environmentally tenuous. As a result, implementation of renewable energy storage technologies may be hindered, resulting in limited commercial implementation. Accordingly, there is an impetus to improve current renewable energy storage technology, including, for example, by increasing the efficiency of a renewable energy storage system, by decreasing the expense of a renewable energy storage system, by increasing the efficacy of a renewable energy storage system, by decreasing the cost of installing a renewable energy storage system, by creating a renewable energy storage system more capable of adjusting to intervening regulations, by decreasing deleterious environmental effects of renewable energy storage, and by increasing the accessibility of materials associated with constructing a renewable energy storage system.

Consequently, there exists a need for further improvements in renewable energy storage technology to overcome the aforementioned technical challenges and other challenges not mentioned.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a control system for a gravity well may be provided. The control system may include an active front end (AFE) controller configured to receive a plurality of reference signals and a plurality of target control parameters, the plurality of reference signals comprising at least one of a power reference and a voltage reference (Vref). The control system may include a rate limiter coupled to the AFE controller and configured to adjust a rate of change associated with each of the plurality of target control parameters based, at least in part, on the plurality of reference signals. The control system may include a speed control loop coupled to the AFE controller and configured to communicate with a variable-frequency drive (VFD), the VFD configured to store the plurality of target control parameters. The control system may include an AFE component coupled to the AFE controller and configured to communicate with a grid based on the plurality of target control parameters.

In another embodiment, a control system for a gravity well is provided. The control system may include a controller. The control system may include a plurality of sensors coupled to the controller. The control system may include a power control system (PCS) coupled to the controller, the PCS further including an active front end (AFE) component configured to communicate with a grid based, at least in part, on a plurality of target control parameters and a plurality of reference signals, the plurality of target control parameters and the plurality of reference signals generated based on signals from the plurality of sensors; and a variable-frequency drive (VFD) and configured to store the plurality of target control parameters.

In a further embodiment, a method for controlling charge or discharge of a gravity well or gravity well system is provided, The method may include receiving, at an active front end (AFE) controller, a plurality of reference signals and a plurality of target control parameters, the plurality of reference signals comprising at least one of a power reference, a speed reference, and a voltage reference (V_{ref}). The method may include adjusting, based at least in part on the plurality of reference signals, a rate of change associated with each of the plurality of target control parameters. The method may include storing, at a variable-frequency drive (VFD), the plurality of target control parameters.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only example embodiments and are therefore not to be considered limiting of its scope, and may admit to other equally effective embodiments.

FIG. 1 is an example schematic diagram of a contemporary power system.

FIG. 2 is an example isometric view of a potential energy storage system, according to at least one embodiment of the present disclosure.

FIG. 3 is a drum-end side view of a potential energy storage system, according to at least one embodiment of the present disclosure.

FIG. 4 is an example top view of a potential energy storage system, according to at least one embodiment of the present disclosure.

FIG. 5 is a control-panel side view of a potential energy storage system, according to at least one embodiment of the present disclosure.

FIG. 6 is a motor-side side view of a potential energy storage system, according to at least one embodiment of the present disclosure.

FIG. 7 is an example flow diagram for a potential energy storage system procedure, according to at least one embodiment of the present disclosure.

FIGS. 8 and 9 are example block diagrams of gravity well systems having one or more control elements, according to at least one embodiment of the present disclosure.

FIG. 10 is an example block diagram of an illustrative gravity well system, according to at least one embodiment of the present disclosure.

FIG. 11 is an example block diagram of a local power output management system used in conjunction with a gravity well system, according to at least one embodiment of the present disclosure.

FIG. 12 is an example diagram of a control signal pathway that may be used in conjunction with a gravity well system, according to at least one embodiment of the present disclosure.

FIG. 13 is an example plot demonstrating how frequency regulation may occur when operating a gravity well system, according to at least one embodiment of the present disclosure.

FIG. 14 is an example diagram showing two options that are examples of how the well installation electricity discharge, according to at least one embodiment of the present disclosure.

FIG. 15 is an example side-view of a potential energy conversion system, according to at least one embodiment of the present disclosure.

FIG. 16 is an example computer system that may be implemented according to at least one embodiment of the present disclosure.

FIG. 17 is an example power conversion system (PCS) that may be implemented according to at least one embodiment of the present disclosure.

FIG. 18 is an example PCS that may be implemented according to at least one embodiment of the present disclosure.

FIG. 19 is an example PCS that may be implemented according to at least one embodiment of the present disclosure.

### DETAILED DESCRIPTION

The present disclosure relates to energy storage, and more specifically to remote and collective control of gravity energy storage resources capable of converting potential energy to electrical energy utilizing wellbores for the generation of energy storage services.

Markets are being created for a large variety of valuable energy storage services, each with different incentive structures to the precise control of an energy storage resource's charge and discharge rates. Arbitrage, firming capacity, peaking capacity, ancillary services, operating reserves, transmission and distribution upgrade deferrals, and black start services are examples of these markets, many of which are in their nascent stages, with compensation structures frequently under revision. In addition to the services market, there are interoperability conditions. This is the set of operational conditions that may determine the precision and accuracy of control that is needed for a given interconnection as well as the modes, functions, and protections that overlay the services that the energy storage system is providing. The control scheme described in the present disclosure provides a level of control that is capable of maximizing profitability in any of these markets.

Energy generation from renewable resources accounts for a significant portion of energy utilization. However, renewable resources such as wind and solar power are unreliable for consistent power generation because they rely on resources that are only available at intermittent intervals. Often, wind and solar power sources are unable to produce electricity in lockstep with demand. Accordingly, energy sources such as natural gas power, nuclear power, coal power, and the like remain dominant despite environmental concerns.

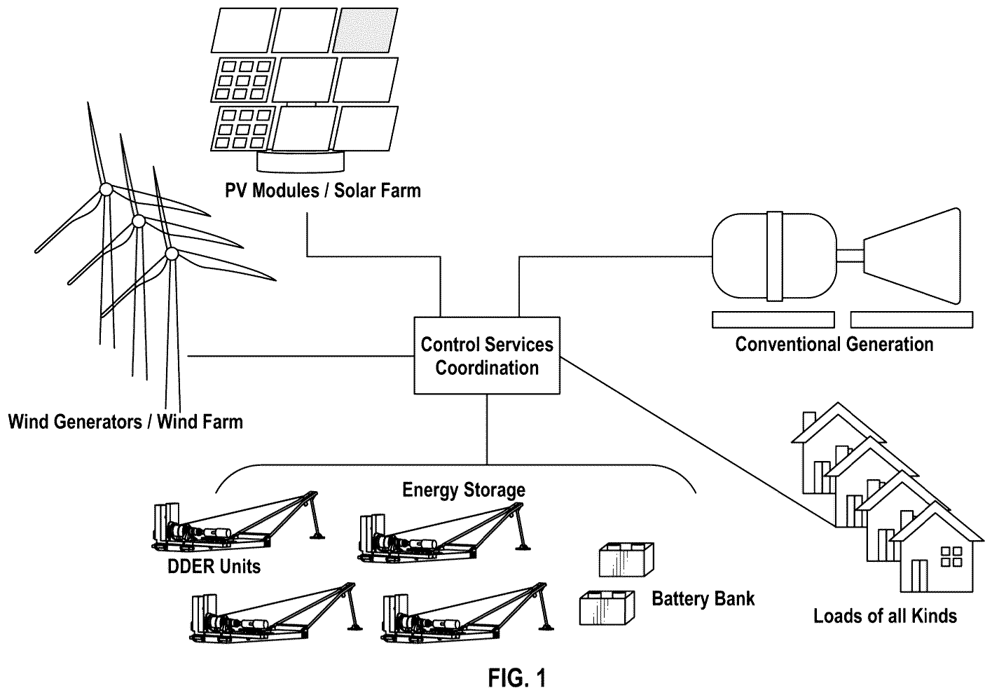

Contemporary power systems are instead evolving with a variety of Dispatchable Distributed Energy Resources (DDER). As FIG. 1 illustrates, a contemporary power system consists of conventional generation (which includes various hydroelectric approaches), plus distributed energy sources of photovoltaic and other types of solar generation as well as wind-powered sources. Due to the intermittent nature of wind and solar and limited ability to schedule power delivery, energy storage mechanisms are needed to complement existing wind and solar generation. These storage mechanisms can charge during times of surplus generation from wind and solar sources, and discharge into the power system during times of need. Control Services Coordination is needed to balance discharge of stored energy into the power system while balancing loads of various types that withdraw the energy from the power system.

Several mechanisms for storing generated energy have been proposed and some implemented. One approach is gravity-based potential energy storage.

Gravity-based potential energy storage is also a feasible approach for mitigating intermittent power generation. In such energy storage systems, a mass is movable and electrical power is input to mechanically elevate the mass to a higher elevation when excess power is available. The stored potential energy is then converted back to electricity in response to demand by lowering the mass and driving a mechanical generator. Using modern winches and generators, gravity-based systems can achieve high storage efficiency, with losses often below about 20%. Gravity-based systems are often less susceptible to the environmental impact and government regulations associated with Pumped Hydro approaches but may be made available only via installation and maintenance of expensive infrastructure. For example, gravity-based systems may be made available only via construction of a tower or pit to provide the difference in elevation for raising and lowering a movable mass. As the elevation difference increases to afford more energy storage capacity, construction costs may increase as well. The combined effects of large initial capital expenditure and unsightly visual impacts can render gravity-based systems impractical and uneconomical in some cases. Suspension of increasingly larger masses may improve the storage potential, but this approach may face limits as well.

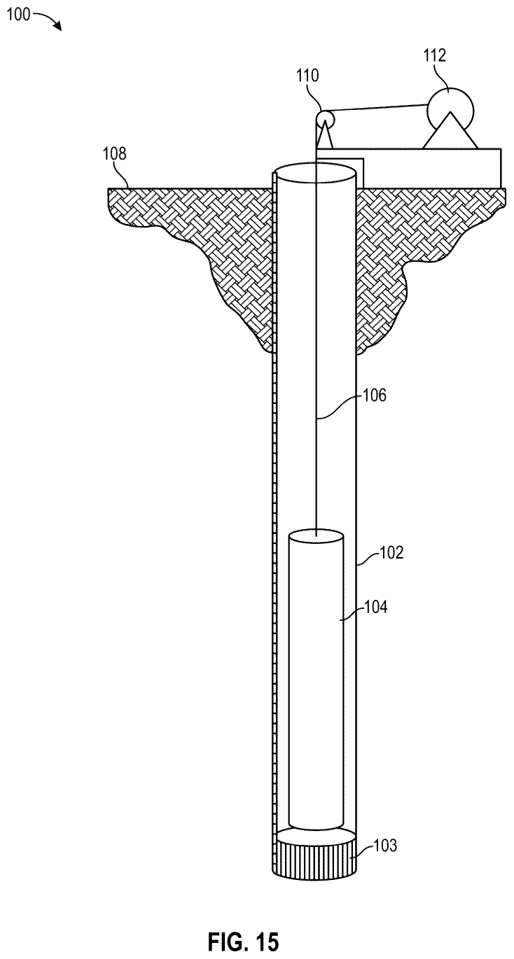

FIG. 15 is an illustration of a potential energy conversion system 100 (gravity energy storage system) housed in well 102 in accordance with the present disclosure. A movable mass 104 (weight) is suspended in well 102 and travels within well 102 extending between the surface 108 and a plug 103 placed at some depth (e.g., thousands of feet) in the well 102. Plug 103 may isolate an upper section of well 103 from a lower section, with mass 104 being located in the upper section. Movable mass 104 may include any object of suitable weight dimensioned for emplacement and movement within well 102. In one example, movable mass 104 may be created from steel tubing that is filled with iron ore pellets and fluid to increase the weight and/or density. Movable mass 104 may also include one or more dense metals (e.g., tantalum or tungsten) and/or high-density fillers, such as depleted uranium, cement, sand, and the like. Movable mass 104 is suspended by a line 106, such as, but not limited to, a cable, wire rope, chain, synthetic rope, or the like. Line 106 connects the movable mass 104 to an electric motor capable of raising and lowering the movable mass 104 during operation, such as winch 112. The connection between movable mass 104 and winch 112 may include one or more sheave pulleys 110 or similar mechanical components that re-direct the force on line 106 as needed. The suspension components, including support line 106, winch 112, and sheave pulleys 110 may also incorporate a number of swivels or other protection devices in-line that prevent damage to support line 106 such as from twisting, binding, abrading, and the like.

Winch 112 may be a regenerative winch that can expend power by spooling up the line 106 to elevate the movable mass 104, and also generate electricity when operated in reverse as the line 106 is extended to lower movable mass 104 downward under the influence of gravity. Regenerative winches suitable for use in potential energy conversion systems may supply electricity as needed (e.g., to the electrical grid), or may be configured to transfer electricity to another storage medium, such as a battery or supercapacitor.

Alternately, winch 112 may be a standard winch that operates to raise the movable mass 102, while a separate generator (not shown) is mechanically connected to movable mass 104 to generate electricity as movable mass 104 is lowered within the well 102. Line 102 may be decoupled between winch 112 and a separate generator to provide raising or lowering capabilities as needed, or a second line 106 may be coupled to the separate generator. For example, a winch 112 and separate generator may be deployed such that the winch 112 drives a spool when elevating the mass 104 and the generator (not pictured) is driven when lowering the mass 104 through gears or other means of interfacing with the spool, such that each task can be performed separately and, if necessary, optimized for efficiency consideration of winching or power generation. It is also within the scope of this disclosure that multiple winches 112 may be used to control one or more movable masses 104, where at least one of the multiple winches 112 are regenerative winches. Further, while system 100 is shown with sheave pulleys 110 and winch 112, other suitable mechanical devices or electric motors may be used interchangeably including the use of a hoist, crane, or other suitable lifting device.

The movable mass 104 may be centered in the well 102 using a series of centralizers (not shown) along the length of the movable mass 104. Centralizers suitable for stabilizing movable mass 104 may be designed such that only incidental contact occurs as the movable mass 104 transits within the well 102. Centralizers may also serve to mitigate casing wear by providing a sacrificial surface (a softer material than the well walls, for example) and by minimizing friction through other methods such as the shape of the centralizer, and material selection for coefficients of friction with casing material or fluid in wellbore. By reducing friction in the potential energy conversion systems (100, etc.), centralizers may also improve energy efficiency and round-trip efficiency, thereby mitigating energy loss by decreasing casing-to-weight surface friction, viscous drag, and resistive pressure force through shape and material selection. The diameter of the centralizers may vary depending on the application, and may be gauged to account features within the well, such as overall diameter of the casing in the well 102, bends and deviations within the well 102, and other factors familiar to those in the art of emplacement of wellbore tools. Centralizers installed on movable mass 104 may be made from any suitable material for use in oil well centralizers, including ultrahigh molecular weight polyethylene, for example.

Fluids may be installed in well 102 in the section through which movable mass 104 transits (e.g., above the plug). Suitable fluids may include any cased well compatible aqueous fluids known in the art of wellbore drilling and production. The fluid may be water, optionally including one or more additives. Suitable additives may include those to minimize corrosion and/or modify various rheological properties. For example, a suitable fluid may include additives such as nanosodium silicate at a concentration in a parts per million range (ppm, e.g., up to about 100 ppm) to coat steel components of the potential energy conversion systems against corrosion, reduce friction between guide and steel, and to otherwise reduce overall drag as the mass is moved up and down within the well. In another example, a fluid in the well may include high-density brines or chemicals to maintain hydrostatic pressure to minimize well casing damage and limit inadvertent ingress of hydrocarbons into the wellbore section where the suspended mass resides. In non-limiting examples, the fluid in the well may include one or more of biocides, anti-corrosion chemicals, and scale inhibitors to prevent damage to the potential energy conversion systems during extended deployment in the well. Regardless of the type of fluid within the well, the fluid may provide buoyancy to the mass within the well and promote smooth movement therein as a result. Preferably, the interval of the well in which the mass moves is filled with fluid over the entire range through which the mass travels so as to maintain constant buoyancy over the range of travel.

Proper control of a distributed gravity energy storage system is beneficial to its resilient, profitable, and safe operation. To accomplish this, the gravity energy storage system can be applied to the energy storage problem in a multiplicity of ways. Systems and methods provided herein can offer both short and long duration storage solutions without losing potential energy, derating and placing undesired operational stress on the system or components. Because of its innate flexibility, it is suitable to a broader range of applications than the typical energy storage system. While some applications rely on fixed or known quantities of demand and/or energy, other applications present more dynamic conditions. The necessary variations in speed, time and depth of discharge may be facilitated using a sophisticated control solution that can manage one or more wells within range of operating points. The operating points are a combination of parameters. Some parameters have calculated values, while others can be manipulated by the user, whether remotely or locally. The parameter accuracies may be variable, thus the control system's response accuracy, speed and resolution can be tuned to meet different criteria. There are three levels of control that may be managed, each with unique challenges: 1) Each individual well during its charging and discharging; 2) The collective group of wells during an aggregated charge or discharge cycle; and 3) The economic controls that rely on market data and other inputs to orchestrate the dispatching of the resources' faculties.

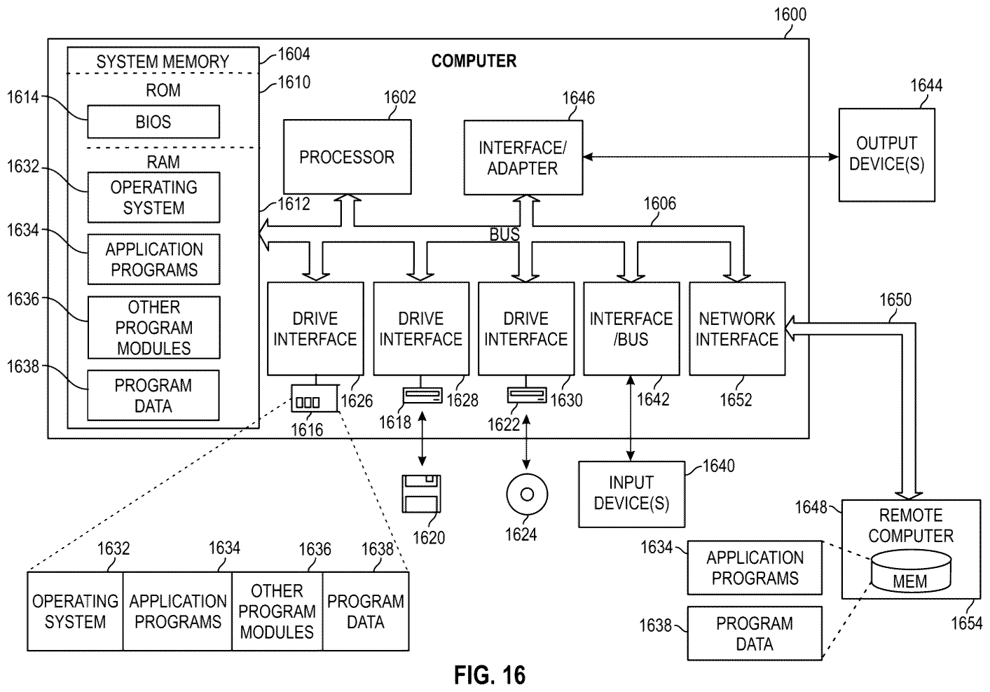

During the discharge cycle of an individual well, the power can be maintained at a steady output, which may be facilitated by adjusting the velocity of the weight to maintain a constant torque/resistance during its descent. Alternately, the descent velocity and torque/resistance can be varied between minimum and maximum values and with it the power is varied as well. Maintaining a constant power output may be challenging where a well has a narrow geometry. In some cases, maintaining constant power is further challenged in cases where the casing remains fluid-filled during operation. To actively compensate for these characteristics, each well's potential energy storage system may have an edge-computing system (e.g., the computer system described with respect to FIGS. 16-18), or a computing system (e.g., the computer system described with respect to FIGS. 16-18) handling multiple wells, that measures performance characteristics and responds to changes in order to maintain a desired power output. Each system may also incorporate historical data and wellbore surveys from that specific well or other wells in order to optimize the power output. The computing system may use multiple sensors arranged within the system to measure the input and output characteristics of the mechanical and electrical sub-systems. The array of sensor feedback may determine the adjustments needed and dispatch digital and analog communications with the devices within the system. For example, a subset of the applications that may be managed by the edge computing system and the array(s) of connected sensors are: the velocity of the weight, the real power absorbed by the system, the voltage of the system and the financial viability of a given charge or discharge schedule based on real-time or day ahead energy market pricing. In at least one embodiment, participating in the day ahead wholesale electricity market may ingest data from demand, weather, and market data sources in order to execute economic and grid support operations simultaneously (e.g., at or near the same time). In another embodiment, operation as a peak shaving energy storage plant may provide a demand driven power output to the grid during peak demand hours, and charging off the grid during low demand hours. The aforementioned list of operations is only a subset of the possible operations and is not to be construed with the totality of operations of which the computing system is capable, the array of sensors and the controlling algorithms are able to produce. The creation and synchronization of an aggregated charge or discharge cycle may be dispatched by a centralized control system. The aggregate and distributed controllers, located at each individual well, may need to communicate with precise timing to initiate and curtail charge and discharge cycles. The centralized control system may convert charge and discharge requests into the ideal charge/discharge sequence (including simultaneous dispatches) to match the desired charge or discharge profile, demand or market opportunity. The initiation and termination of these charge and discharge cycles may need to be very precisely timed during transitions in order to maintain the desired operational fidelity and power quality of the aggregated system.

Gravity energy storage in oil and gas wells can be inherently unstable. The inherent instability may be managed by a sophisticated control system to maximize value to the grid, as provided in systems and methods of the present disclosure. For example, when the system is discharging, the weight moving downward within the well at a steady-state velocity may enable a relatively steady power output. However, certain interoperability parameters make it such that a gravity well would have to operate over a range of charge and discharge rates, with certain protections embedded to protect the stability of the power infrastructure as well as the energy storage installation.

The energy storage device powertrain, otherwise described as the power conversion system (PCS) may have to possess the capability to curtail or limit real power, regulate voltage, reactive power, “ride-thru”, anti-island, or trip, depending on the underlying power conditions and parameters present at the point of common coupling between the grid and the energy storage installation. Some iterations of this design may allow for the collocation of renewable power generation assets (e.g., solar or wind), which utilize the same conversion infrastructure, to generate power whilst the energy storage device could simultaneously charge or discharge. This may further expand the range of applications that are possible for the system to achieve, including but not limited to multiple charge and discharge cycles throughout a day, and charging and generating simultaneously.

Such a system implies that each system has a unique control setpoint signal, c(t), resulting in a high degree of precision across each individual system. There are other situations, with less demanding electrical conditions and/or variation in well geometries, that would allow for a simpler control scheme. One possibility is through controlling multiple gravity well motor/generator systems in parallel. The response of each energy storage device in a parallel system would be the same or essentially the same. For N systems operating in parallel, the response may be proportional to the control signal, x(t), multiplied by the number of systems, N, as the control signal would be broadcast to each motor/generator.

In at least one embodiment, a subset of multiple gravity well motor/generator systems may be controlled sequentially using a single controller. This approach may yield a long duration discharge during which the response of each energy storage device may be precisely controlled.

In at least one embodiment, the control algorithm and system design may use synchronous control of the motor/generator. Such situations imply that the weight ascends and descends at a constant rate that corresponds to the AC motor generator operating in such a way that it is electrically synchronized with the grid. These latter options imply a trade off; reducing the overall cost and complexity of the control apparatus while sacrificing the robustness of possible applications.

These abilities may need precise and timely measurement and control of the energy storage power delivery apparatus at a range of operating points. The power output (in horsepower) is determined by the torque and speed (RPM) of the motor/generator at a given time (HP=T×RPM/5252), with both an increase in torque and an increase in speed correlating with increased power output, and vice versa. The control system and multiplicity of sensors facilitate control of the energy storage system through motor/generator speed control. The network of sensors allow one to derive the system voltage and electrical frequency of the power flow in the windings of the motor/generator. Through manipulation of these parameters, one can determine the rate of controlled ascent and descent of the weight through the well and thus, the system can behave as a power source (e.g., re-generator) or a power sink (motor) depending on the signals communicated to the subsystems by the edge computing device.

In at least one embodiment, when wells have constantly changing inclination and curvature, if the generator/motor settings are maintained, the velocity of the weight is constantly changed by corresponding changes in viscous drag, resistive pressure force, and contact friction with the well's casing. When the weight's velocity increases (e.g., accelerates) above the target rate of descent, the power output of the generator increases beyond the desired setpoint. The control platform responds quickly, in one embodiment where the sensors are arranged to measure torque, by generating an opposing torque (e.g., increasing power output and EMF) to stop the acceleration or it runs the risk of exceeding the generator's torque/speed capabilities. Once the acceleration has stopped, the weight is now moving at a higher steady-state velocity, which fixes the rate of power output above the target. In order to correct for this, the motor may then decelerate the weight by applying more torque, and increasing power further in the short term to achieve the desired power output. The instability of the system refers to this need to further increase power output in order to compensate for an above-target power output, making small changes in velocity very impactful on the system's output.

The generator can be controlled to deliver a certain amount of power at a single speed and torque, a range of power inputs and outputs over a range of speeds and constant torque or a range of power inputs and outputs over a range of speeds and torques. Control of speed and torque allow a balancing act to occur that may return the system power output to the desired setpoint. The control system and array of sensors and actuators may allow one to manipulate the generator's speed or torque through manipulation of terminal voltage waveforms and/or electrical frequency of the motor/generator.

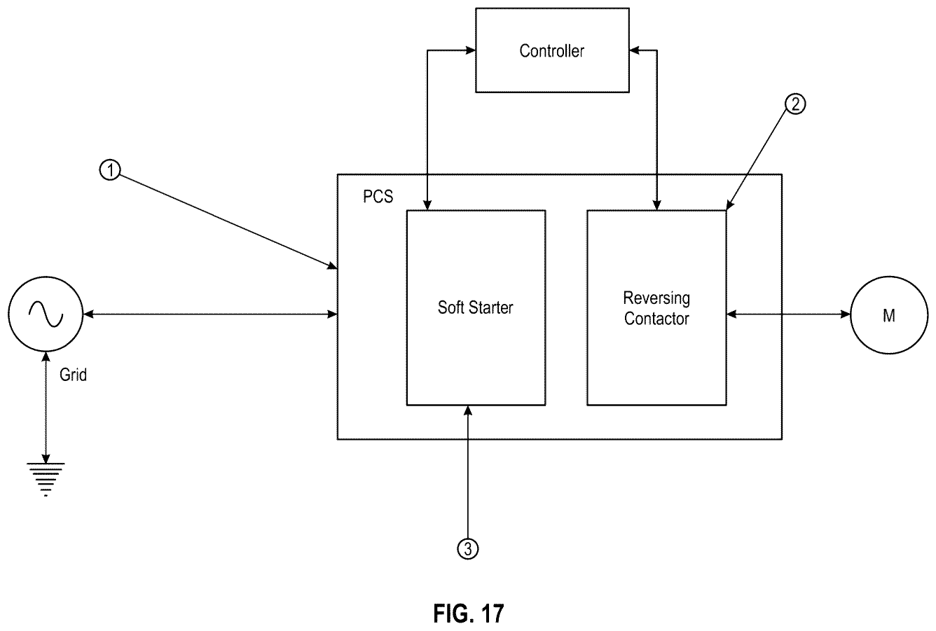

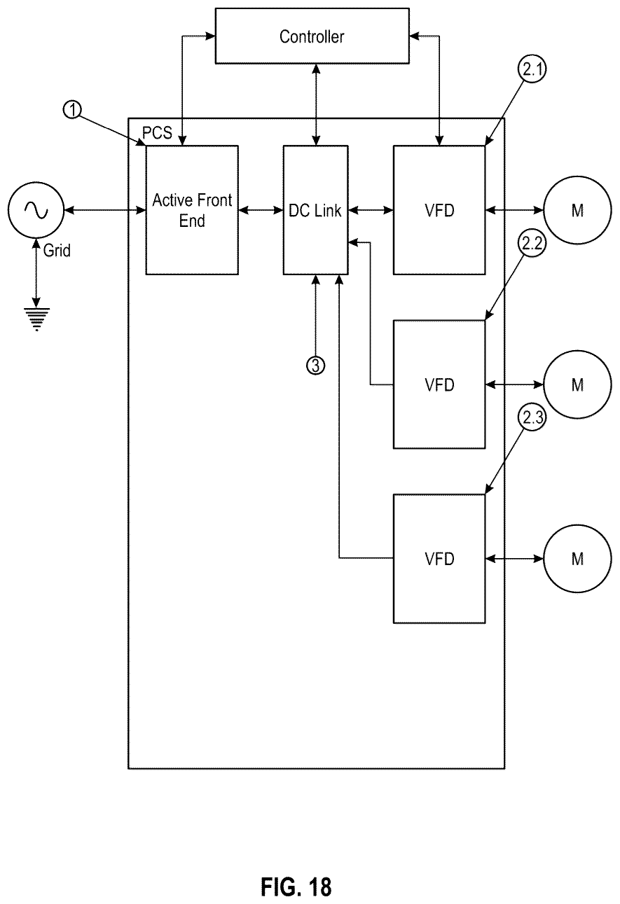

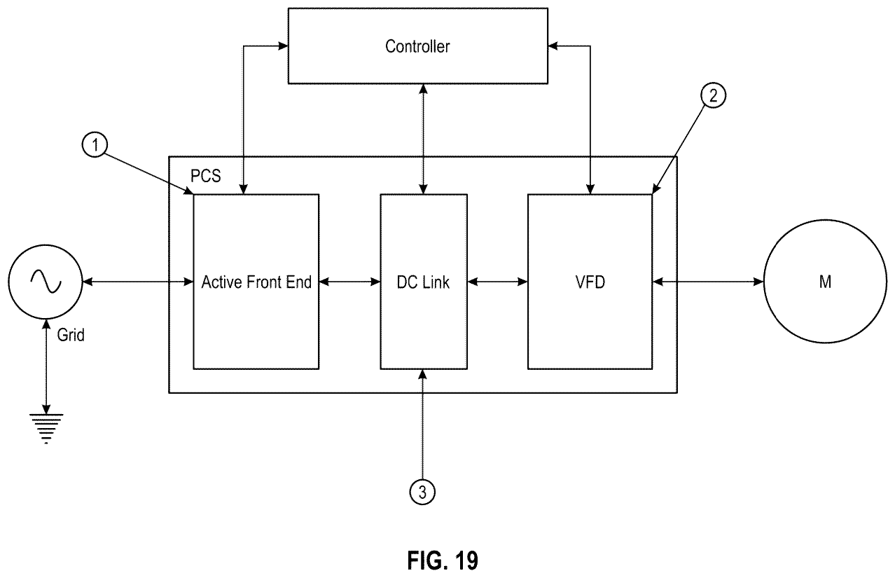

In stable systems there are two methods of controlling the system output; where instability is inherent there is an additional method that can be used to mitigate inherent system instability. Each embodiment of the PCS can deliver a range of services related to the system's electrical output. Separate from individual PCS control methods listed above, there may be two separate systems utilized to monitor each and co-operate a multiplicity of gravity wells as one larger system of systems. In total, there are three PCS control embodiments each with supervisory control and data acquisition (SCADA) or power output management system (POMS) coordination controller and one collective or aggregate control system for a total of five subsystem embodiments described in more detail below. Various embodiments of a PCS that may be implemented as part of the systems described herein may be understood with further reference to the example PCS configurations illustrated in FIG. 17, FIG. 18, and FIG. 19.

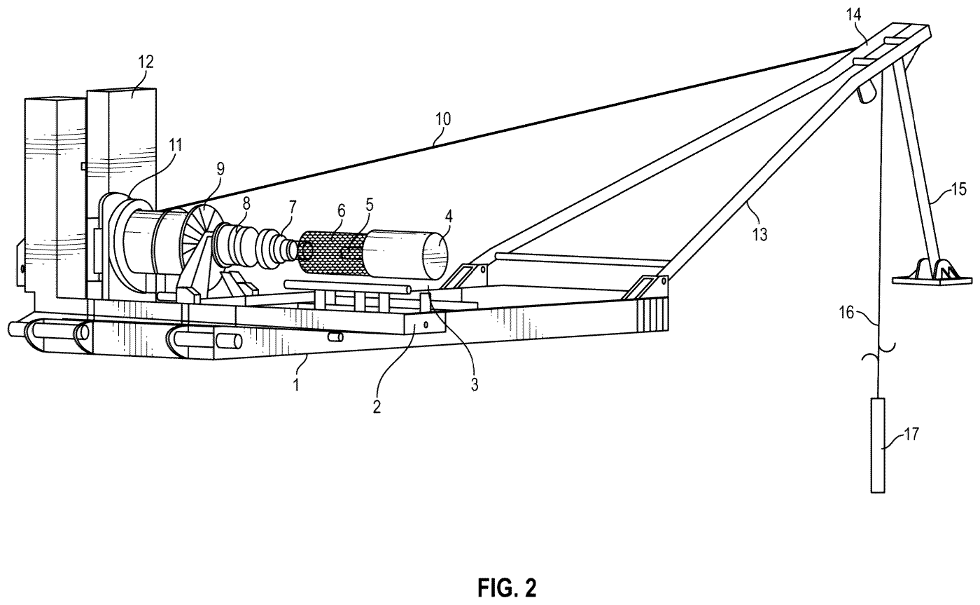

FIG. 2 is an overview of the potential energy storage systems disclosed herein. In one embodiment, shown in FIG. 2, the mechanism is constructed on a skid 1. This skid is suitable for transport using commonly available oil field service equipment. To aid in transport, the operational components are built on top of a swivel frame 2. In one embodiment, the winch and motor drive of swivel frame 2 is rotated parallel to the skid 1 during transport and is rotated perpendicular to the skid 1 for operation. A motor/generator 4 is mounted on the swivel frame 2 using an adjustable motor mount frame 3.

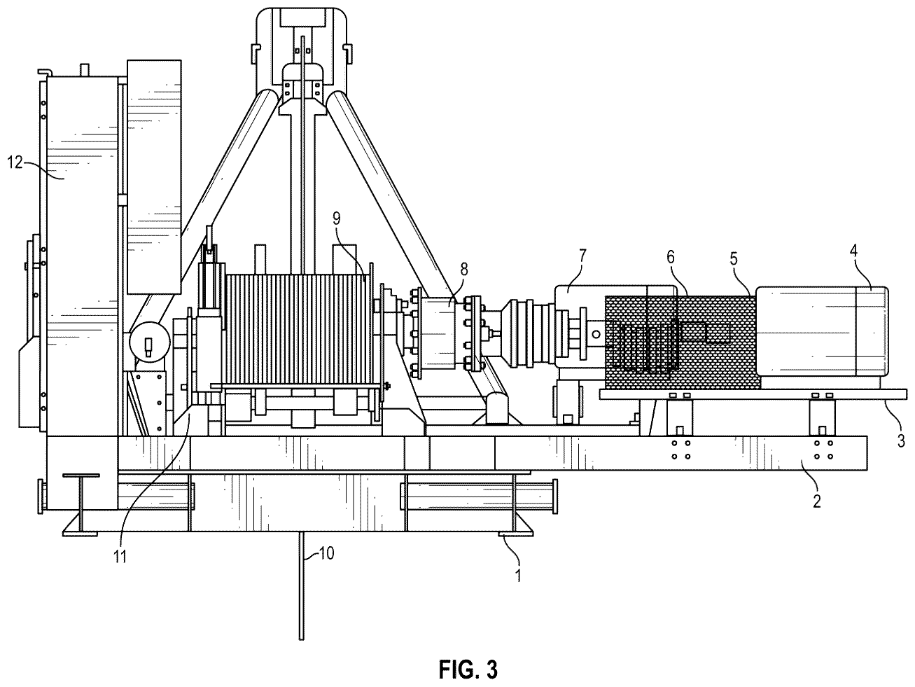

FIG. 3 is a drum-end view of a potential energy storage system of the present disclosure. As shown in FIG. 3, the motor 4 is connected to a cable drum 9 through a coupling 6 connected to a gearbox 7 and another coupling 8. In one embodiment, a rotary torque transducer 5 is used between the motor 4 and the coupling 6. In one embodiment, the coupling 8 has an integral reaction torque transducer.

The cable 10 may be wound onto the drum 9. A weight 17 can be raised from and/or lowered into a well using a motor drive assembly control mechanism 12. In one embodiment, the weight 17 is guided in and out of the well by means of the cable 10 and the A-frame boom 13 and the boom support 15. In one embodiment, there is a sheave tachometer 14 that is used to measure cable speed. In one embodiment, the sheave tachometer 14 also measures cable travel distance.

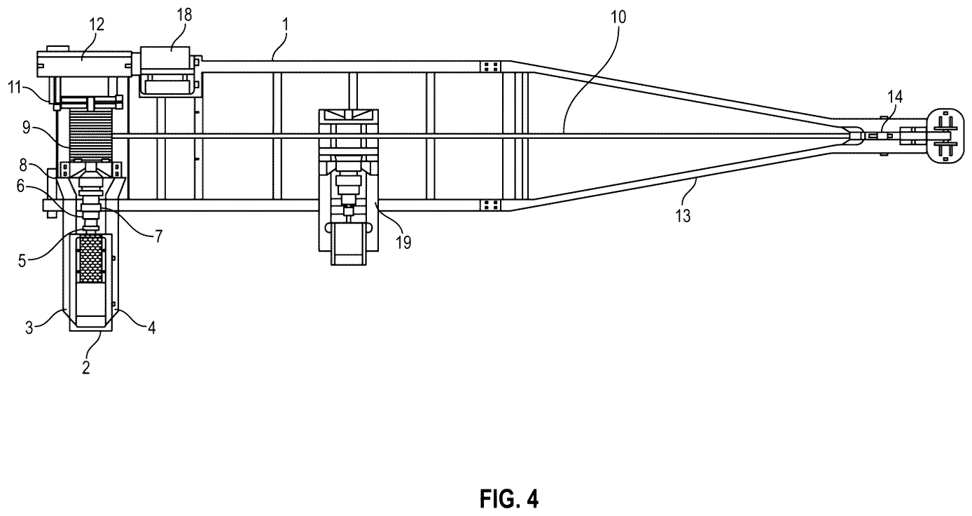

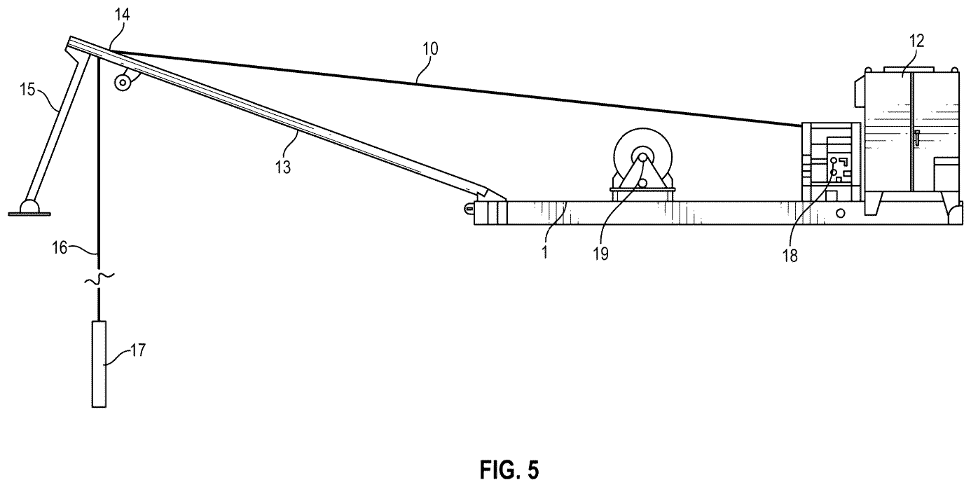

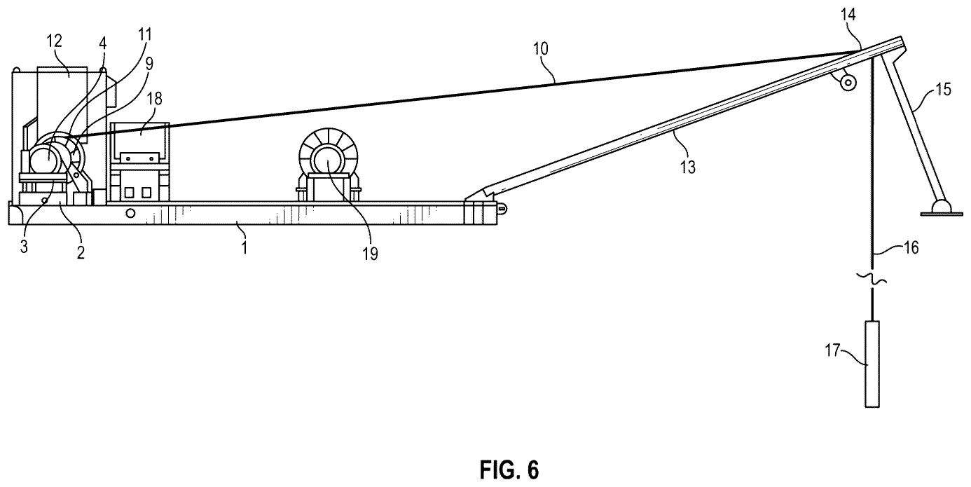

When not in use, or when it is desired for the cable to stop, a braking mechanism 11 is used. FIG. 4 is a top view of a potential energy storage system of the present disclosure. FIG. 5 is a control panel side view of a potential energy storage system of the present disclosure. FIG. 6 is a motor side view of a potential energy storage system of the present disclosure. As shown in FIGS. 4-6, the braking mechanism 11 is controlled by the brake control assembly 18.

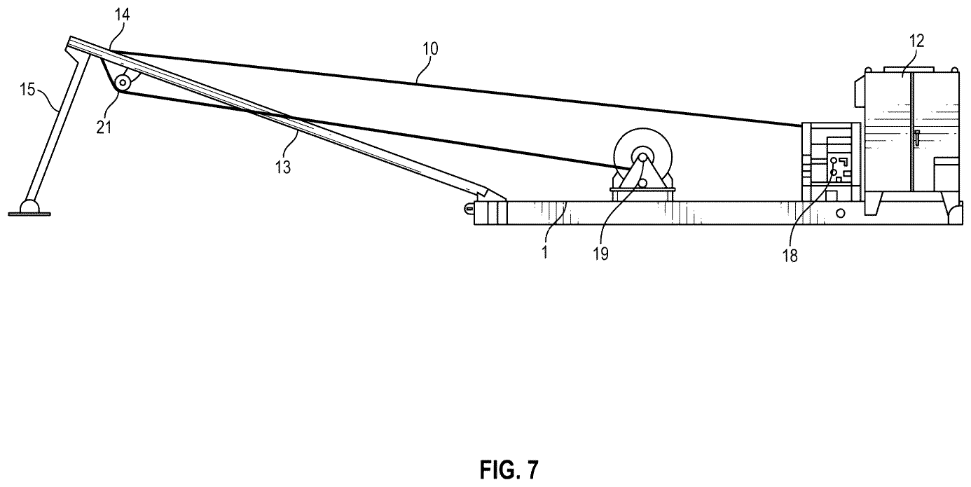

There is provision to construct a well for testing the system. FIG. 7 is a construction and test configuration of a potential energy storage system of the present disclosure. The testing may be accomplished using a weight model and testing assembly 19. In this embodiment, the cable 10 is routed around both the primary sheave 20 and the ancillary sheave 21 to the cable drum on the weight model and testing assembly 19, as shown in FIG. 7.

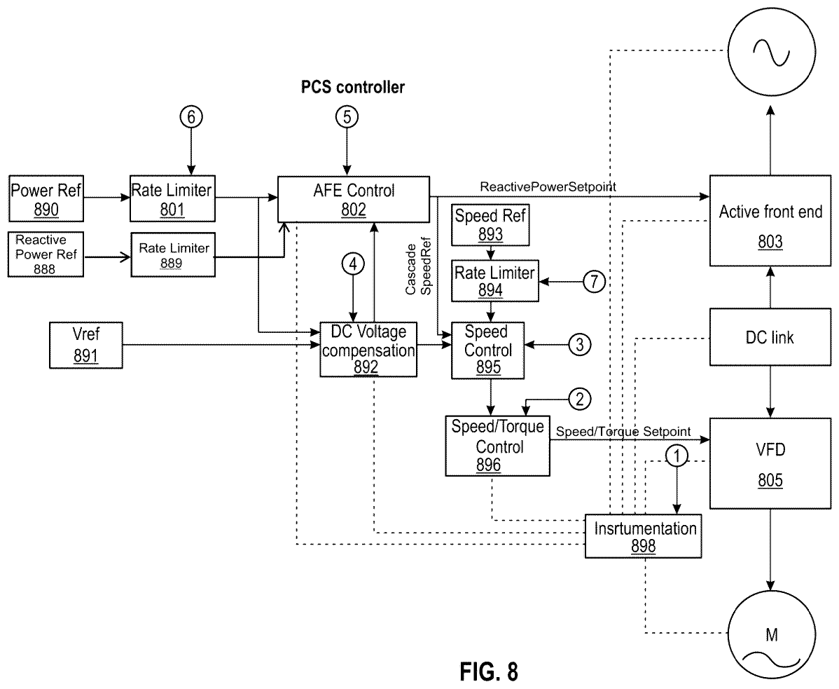

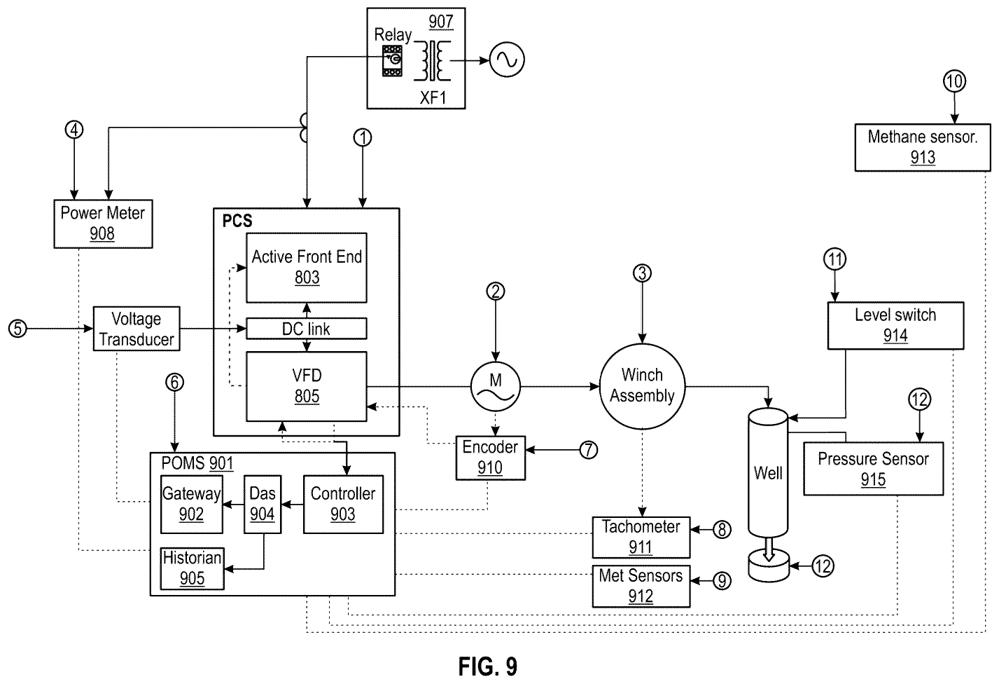

FIGS. 8 and 9 are example block diagrams of illustrative gravity well systems, including control elements thereof. In at least one embodiment, where well geometries and electrical conditions permit, the motor/generator output is coupled directly to the distribution grid and may operate the PCS at synchronous speed. “Synchronous speed” may imply that the motor's rotational speed produces AC voltage and current waveforms that are synchronized with the grid frequency (e.g., about 50 Hz or more to about 7 Hz or less, such as about 60 Hz). Such situations may imply that the weight ascends and descends at a constant rate that corresponds to the AC motor generator operating in such a way that it is electrically synchronized with the grid. In this configuration, the control system may connect the AC motor/generator to the grid when the weight is ascending/descending at a velocity corresponding to synchronous rotation speed. The speed is measured via sheave tachometer or equivalent. When the speed exceeds synchronous speed, a braking control mechanism can be applied to slow the weight and return the rotational speed of the motor generator to synchronous speed and released when synchronous speed has been reached again.

Another method of control that can be utilized in an inherently stable system is for a multiplicity (N) of PCS assemblies to be interconnected to one grid interface assembly such that the speed of the motor/generator assemblies are variable and decoupled from the distribution grid via a DC link. The DC links are connected to an individual grid coupled AC link. In such an embodiment, N AC motor/generator assemblies are commonly coupled to a DC bus, AC-DC coupling, and the multiplicity of DC bus couplings, which may be connected to an additional AC coupled, grid connected inverter assembly to create a AC-DC-AC coupling. This configuration may allow N PCS assemblies to be controlled at a variable speed, but with each motor/generator assembly operating at the same speed. The speed may be measured via sheave tachometer or motor encoder, which may produce feedback signals that are used to control the motor/generator speeds. While the PCS assemblies are operating at a controlled speed, the grid coupled DC-AC inverter may be consuming or producing power, the power synchronized with the grid frequency. In addition, the grid coupled AC inverter can provide a range of ancillary services at the point of common coupling with the grid through utilizing functions built into the inverter that allow power quality (e.g., Power, Voltage, and Power Factor, and the like) to be controlled. Ultimately, the control of the grid coupled inverter and of the multiplicity of PCS may be coordinated such that the incoming and outgoing power corresponds to the sum of incoming and outgoing powers from each PCS assembly. In this arrangement, the AC grid and AC motor/Generator are coupled via DC link, as shown in FIG. 8, and controlled using Four quadrant motoring (Sinking power, clockwise rotation) and regeneration control (Sourcing power, counterclockwise rotation) which utilizes a space vector modulation technique. One embodiment of such a technique could be space vector pulse width modulation (SVPWM). Space vector control results in a greater degree of control because it has a higher degree of freedom and improved utilization of DC supply voltage and improved harmonic characteristics.

In an embodiment where there may be inherent instability due to well geometry or to minimize control response time, precision and operating range, each PCS can constitute an AC-DC-AC coupling, as shown in FIG. 8. Each AC coupled inverter is controlled separately. For example, the grid tied inverter may be commanded to produce a specific amount of power. In such an embodiment the inverter switching may be controlled by an SVPWM (Space vector pulse width modulation) generator. A power reference may be sent to a rate limiter connected to a power control algorithm that considers a plurality of factors and sensory feedback prior to generating inputs to a current reference generator. The current reference generator determines the appropriate quadrature current vectors from the power control algorithm, a current limiting protective algorithm, and the DC link voltage. The current reference is ingested by the current control algorithm and converted to quadrature voltage vectors. A digital signal processing algorithm, the Park transformation, is used to convert the quadrature voltage vectors into stationary vectors. Finally, the stationary vectors are input to the SVPWM generator to create the amplitude and pulse width modulated inverter control signal. A similar signal is generated to control the motor tied inverter, which provides speed control to the motor by varying the average terminal voltage and timing of the pulse width a modulated control signal, thereby controlling the speed of the motor. A similar technique can be used to control the current waveform at the motor terminals in order. Such an embodiment would refer to a torque control algorithm. Either technique can be applied when they offer a utility advantage for certain motor control applications that depend more on providing exact torque in favor of controlling to an exact speed.

In at least one embodiment, as shown in FIG. 8, a power reference 890 is fed to a rate limiter 801. The power reference 809 may be optionally sent to the rate limiter 801 to limit a rate of change for a target control parameter. In at least one embodiment, a reactive power reference 888 may be optionally sent to the rate limiter 889 to limit a rate of change for a target control parameter. The rate limiter 801 may be independent from the rate limiter 889. The rate limiter 889 may be configure to eventually limit the speed and torque of the system. The power reference 890 is then fed to a plurality of control modules (e.g., DC voltage compensation 982) connected to an active front end (AFE) control 802. In some cases, the AFE control 802 considers a plurality of factors and sensory feedback prior to generating inputs to a current reference generator. The AFE control 802 controls the AFE 803, which connects to the grid(s) discussed herein. In at least one embodiment, the AFE 803 processes power and reactive power references and interact with one or more control loops. In at least one embodiment, the AFE 803 is capable of generating and does generate one or more types of signals. For example, the AFE 803 may generate reactive power signals and a speed set point signals. The reactive power signals may be fed directly to the AFE 803. The speed set point may forwarded and/or cascaded via a speed control loop. The speed control loop includes a speed reference 893, a second optional rate limiter 894, and a DC voltage compensation component 892. The speed control loop utilizes feedback from instrumentation 898 to generates a speed and/or torque set point that gets sent to a variable-frequency drive (VFD) 805. Example gravity systems defined herein may be implemented at the VFD 805 (e.g., the space vector, pulse width modulation control scheme). In at least one embodiment, the VFD 805 the VFD processes speed and torque setpoints and interacts with one or more control loops. In at least one embodiment, a voltage reference (Vref) signal may be fed through to the DC voltage compensation component 892 as of the control loop. In at least one embodiment, the Vref may be the voltage level that is to be maintained between the AFE 803 and the VFD 805. In at least one embodiment, the Vref and voltage compensation control may affect either processes associated with the AFE 803, processes associated with the VFD 805, or both. This signal may calibrate AFE 803 control in a manner the is optimal to utilize multiple gravity energy storage devices operating in parallel behind one grid connection. In at least one embodiment, there is a cascaded configuration where the power control loop is cascaded with the speed controller. In at least one embodiment, the reactive power control is decoupled entirely from speed control.

As illustrated in FIG. 9, a data acquisition system 904 and control system 903 are integrated with each gravity well energy storage device, which combined make a POMS system 901. The power output management system (POMS) installation controls the outgoing power flow and power quality via switching VFD 805 operation. The control system 903 parameters can be arranged in a number of different modes depending on the application and within each mode the parameters and accuracies of control response can be manipulated by a user of the system. One such embodiment allows for configurations of certain parameters to occur during operation, while others are changed when the system is de-energized. With a multiplicity of modes, some can operate concurrently, while others are mutually exclusive. One example is the system is capable of operating in a closed loop control mode or an open loop control mode. Another such embodiment is that the system can operate as a standalone unit or it can be controlled in conjunction with many units simultaneously. Control is made possible because of the data acquisition component of the apparatus. The data acquisition is composed of instrumentation that is connected to the equipment and machinery of the gravity well installation, including components 907-915. In at least one embodiment, the data acquisition component may include a relay component 907, a power meter component 908, an encoder 910, and the like. In at least one embodiment, the data acquisition component may include at least one of a plurality of sensors. The plurality of sensors may include a tachometer 911, meteorological sensors 912, a methane sensor 913, a level switch 914, a pressure sensor 915, and the like. The instrumentation measures analog signals, which are converted to digital representations. The data from the instrumentation may be collected via digital communication protocols such as Modbus TCP/RTU, DNP3, Profibus, Canbus, and the like. Some is cached so that periodically it is sent to a cloud-connected server while other data is stored locally in an historian 905. Historical data from previous trips through the well, which serve as maps to assist the control system in providing the ideal motor/generator settings throughout the varying well geometry, may store real-time instrumentation data to support diagnostic and real-time functions such as speed measurements of the wire rope to support a speed control PID and has a bi-directional communication with a centralized cloud computing server for remote operation, data analysis, API services, and asset management capabilities via web gateway 902.

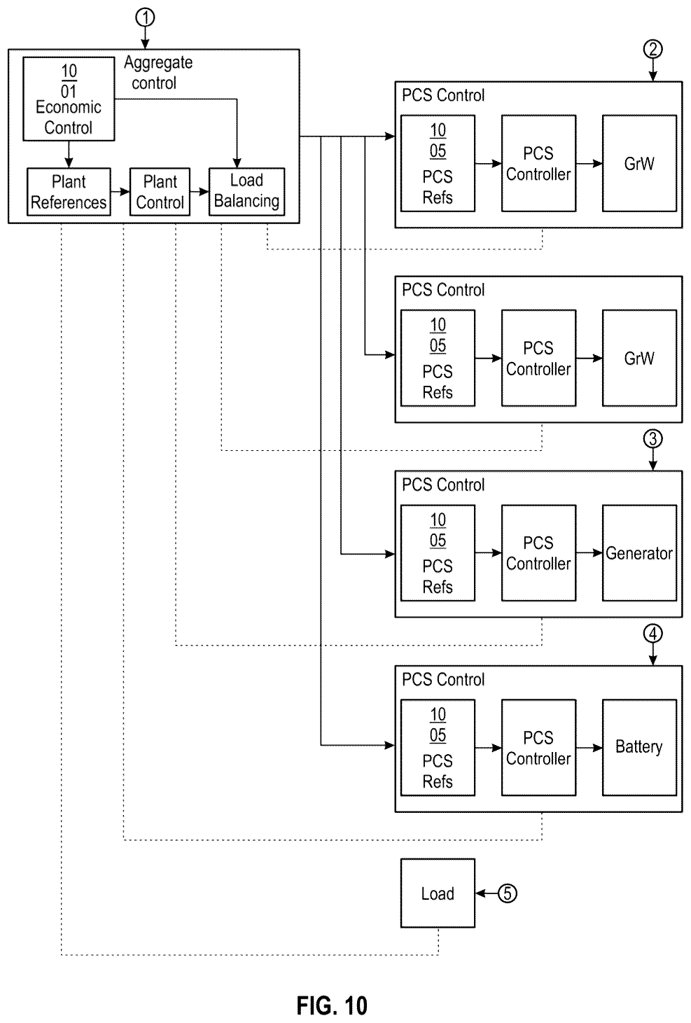

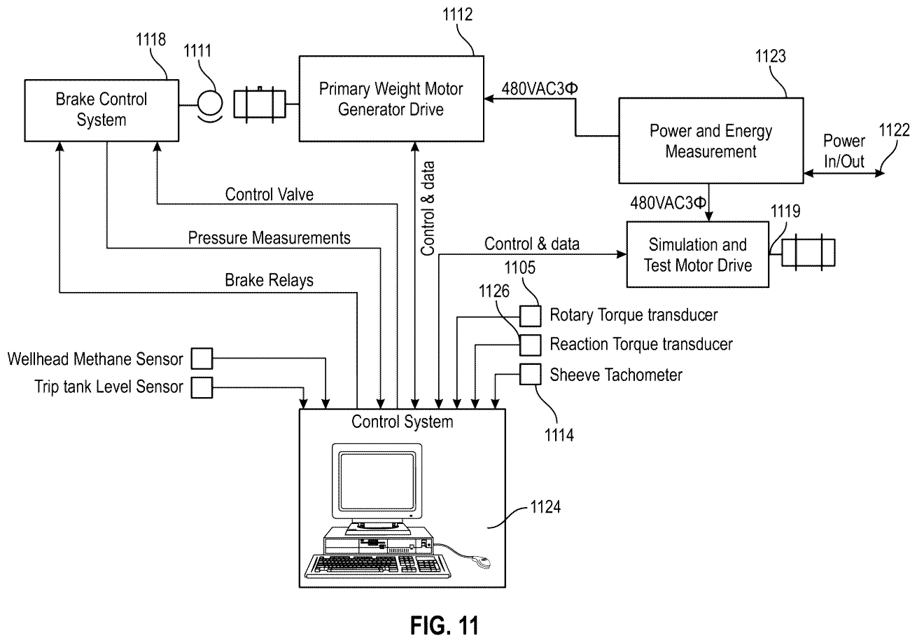

FIG. 10 is a block diagram of an illustrative gravity well system, showing components at an aggregate level. In at least one embodiment, an aggregate control platform can operate as an open or closed loop scheme that balances loading across a multiplicity of gravity well installations to meet the storage service conditions and cause the entire system to adhere with interoperability conditions of the energy storage network and the bulk electric system. The aggregate controller can orchestrate a multiplicity of N gravity wells as one single generator or treat them individually, each with its own control interface 1005. In one embodiment of the aggregate controller there is an economic controller 1001 that ingests real-time power, grid, weather, and market data to determine load profiles for peak shaving, arbitrage, and demand response operations as well as ancillary market services such as voltage regulation, droop curves, and frequency response. The economic controller may be capable of communicating with the automatic generation control functions of the bulk electric system operators and adjusting the input/output targets of the aggregate control system and connected gravity wells as needed.

Relevant historical and real time sensor data may include any of the following to provide the necessary feedback, alone or in combination: Previous charge and discharge cycles. Power input/output measurements from the drive. A metering platform and the grid connection or any other part of the system or the motor. Torque input/output measurements from any shaft or subsystem. Velocity or RPM measurements taken from the weight, wire rope, drum, gearbox, connecting shafts, or any other subsystem. Available mappings for the system may include any of the following, alone or in combination: Wellbore surveys including inclination, depths, dogleg severities (curvatures), cement logs, and any other geometric information about the well. mapping of casing created using caliper tools, EMITs (magnetic imaging tools), ultrasonic tools, meteorological data, and energy market data.

### Power Output Management System

The power output management system features a plurality of sensors throughout the subsystems comprising the energy storage system. The sensors can be affixed on the weight, wellhead, sheave, wire rope, drum, motor, or drive that measure either the speed of the wire rope, angular velocity of the sheave, angular velocity of the drum, angular velocity of the gearbox, angular velocity of the shafts, angular velocity of the motor-generator, or the power input/output of the system, or some combination thereof. These sensors may include Hall effect sensors, accelerometers, microphones, ammeters, voltmeters, photoelectric sensors, or any other relevant sensor. Some embodiments may feature a tachometer or encoder that utilizes a Hall effect or photoelectric sensor on the sheave to constantly measure the speed of the wire rope by a measurement of the rate at which the sheave is turned by the wire rope. This measurement may be combined with historical data to dynamically control the output torque of the motor to compensate for wellbore geometry, changes in wire rope stack height on the drum, and fluid dynamics in order to match the desired power input and output as closely as possible.

These control needs may be further enhanced by an embodiment of the gravity energy storage device where the drum on which the wire rope is stored is also used to apply sufficient tension to the wire rope to lift the weight. In this embodiment, as the weight is lowered in the well (e.g., discharging), the stack of wire rope stored on the drum decreases (and vice versa). A control system may manage this using either one or a combination of two methods: 1) The torque arm in the conversion for line tension to torque decreases, thus lowering the torque applied to the motor. The motor-generator angular velocity can be maintained as constant to maximize efficiency by sacrificing constant power output. As previously mentioned, the power of the system is determined by Horsepower=Torque×RPM/5252, meaning that a decrease in torque creates a corresponding decrease in power as the weight is lowered. 2) The motor-generator angular velocity can be increased during a discharge cycle (it would need to be decreased during a charge cycle) in order to create a constant rate of wire rope travel off the drum. While discharging, the effective radius from the center of the drum to the outermost wire rope layer gets smaller with each layer change of wire rope, which means that the length of wire rope per rotation (i.e., circumference) is also decreasing. Thus, in order to keep the linear velocity of the weight constant, the angular velocity of the motor-generator may be increased. By doing so, it may be possible to maintain a constant power output at a reduced torque. The ability to change the linear velocity is an advantage as it may produce a minimum discharge level of zero and maximum of X kW with smooth range in between, vice versa for charging. The system can tailor power flow with high resolution/fidelity between zero and +/−a nameplate rating and +/−% accuracy for each well. Method (2), described in this paragraph, may provide a constant power output and may enable maximizing revenue in markets where power output consistency is compensated. These two methods may be used to create a charge and discharge profile for each energy storage device that maximizes revenue generation in the energy storage markets where they are currently participating. These embodiment variations are further explained using FIG. 11, which is a block diagram of a local power output management system used in conjunction with a gravity well system according to the present disclosure.

Referring to FIG. 11, a power source 1122 is connected to the electrical grid. A power and energy measurement device 1123 is used to measure, monitor and record phase power and energy in each direction. The primary motor drive 1112 is monitored and controlled by a local control system 1124. In one embodiment, the local control system 1124 also controls and monitors the weight model and test assembly 1119.

In one embodiment, a dynamic brake 1111 is controlled through a brake control assembly 1118. The local control system 1124 communicates measurements and control signals with the brake control assembly 1118. The measurements and control signals could be pressure, valve open/close, valve open percent, or solenoid open/close. In one embodiment, the brake control signal operates a solenoid valve. In another embodiment, the brake control signal sets a needle valve opening amount. This brake could be used to correct any overspeeding of the motor without necessitating the momentary increase in power production described previously by sacrificing that power as friction/heat.

In one embodiment, an external sheave tachometer sensor 1114 is used to calculate the cable speed and distance traveled.

In some embodiments, the weight model and test assembly 1119 is present. In some embodiments, the rotary torque transducer 1105 and the reaction torque transducer 1126 are present. In these embodiments, the system can be used for operational testing and model evaluations. Communication between the motor drives 1112 and 1119 and the local control system 1124 is made possible with one or more than one of a number of network protocols. In one embodiment, a Modbus protocol is used. In another embodiment, Profibus is used. Other protocols, including a proprietary protocol, may be used as well.

### Aggregate Operation

Operating multiple energy storage devices in a coordinated manner may allow the devices to behave as a single energy storage resource with much more flexible characteristics than each individual device on its own. There are many markets in which energy storage can participate and each has its own conditions that the energy storage resource must satisfy to be compensated. For example, to be fully compensated for Resource Adequacy by the California Public Utility Commission (CPUC), the energy storage resource must be able to discharge for at least 4 hours. On the other end of the energy storage market spectrum, some frequency regulation markets adjust in time periods shorter than 15 minutes. When multiple systems are coordinated to respond to market needs, they can be dispatched simultaneously for a high power, short duration charge or discharge cycle (to meet the needs of a frequency regulation market for example), dispatched sequentially in order to create a low power, long duration charge or discharge cycle (to meet the needs of seasonal storage or Resource Adequacy for example), or they can be dispatched in any combination of simultaneous and sequential needed to fulfill the needs of the customer at that time. Selecting the correct mix of markets may facilitate sophisticated planning methods that balance revenue potential, risk, and operating costs to maximize profitability. The control system described in this document may be responsible for delivering the ideal charge and discharge profile, including any duration and storage term. Coordinating multiple devices make be operable via dynamic tracking of each system's state of charge both during and between charge and discharge cycles. The central control system (Dispatch Coordination Hub) may have 2 main responsibilities: 1) Determine which energy storage system should be dispatched at which time in order to match the desired aggregated charge or discharge characteristics (Dispatch Sequence), and 2) Manage the transition between individual energy storage systems in order to mitigate deviation from the desired aggregated charge or discharge characteristics caused by the initialization and stopping of individual storage systems.

To determine the ideal Dispatch Sequence, the control system may analyze the desired aggregated charge or discharge characteristics provided by either the customer (utility, ISO/RTO, behind the meter customer, etc.) or a revenue maximizing algorithm and compare to the immediate capabilities of the aggregated system (state of charge, location, and power rating of each individual system).

To properly transition from one device to another, the Dispatch Coordination Hub may take into account the power rating, and current charge or discharge profile, of each system involved in the transition as well as their individual charge/discharge initialization or stopping profiles. The initialization/stopping profiles refer to the way that power output changes as the system initiates or stops a charge or discharge. These profiles are affected by the inherent instability of the system and can be adjusted to accommodate the desired input/output power characteristics. For example, the deceleration of a descending weight can be performed over a long period of time in order to create a profile that is more easily mirrored by the acceleration of the weight of the next energy storage system being dispatched in the Dispatch Sequence.

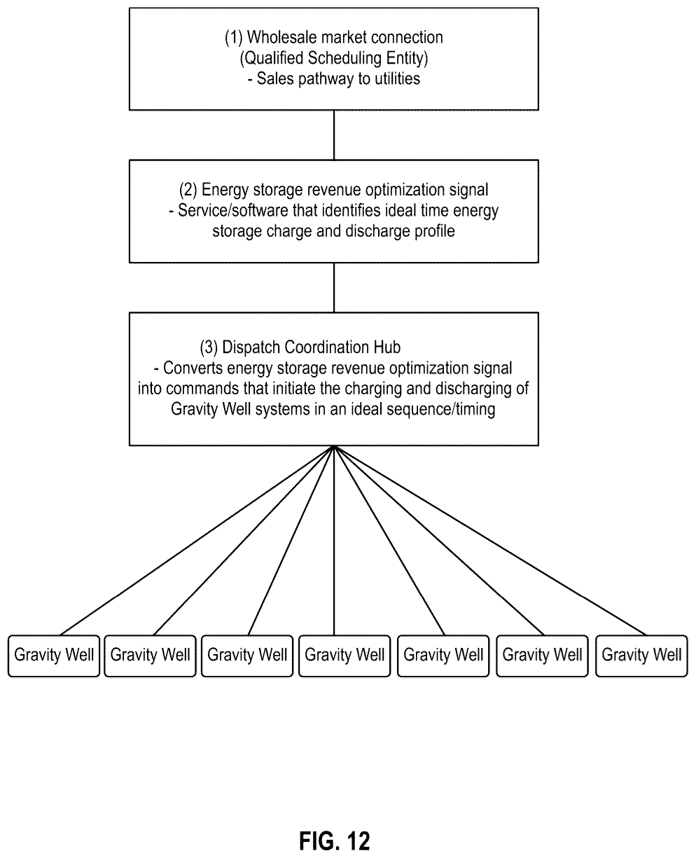

A charge or discharge initiation may be prompted either directly from the utility (if they have been given control of the device) or through an energy storage revenue optimization service. This process is described in FIG. 12, which is an illustrative control signal pathway that may be used in conjunction with a gravity well system according to the present disclosure. The energy storage revenue optimization signal (2) may be removed from the process in a case where the utility has direct control over the energy storage system(s).

Using one or more of the embodiments, there are several Dispatchable Distributed Energy Resource (DDER) services that can be provided to the Ancillary Service (A/S) Market of domestic electrical grids.

Communication to and from the wells may be handled by a communications platform including both hardware and software (e.g., the computer system of FIG. 16). The hardware may receive, analyze, and relay communications as needed between the wells and the energy storage customer.

### Frequency Regulation Service (FRS)

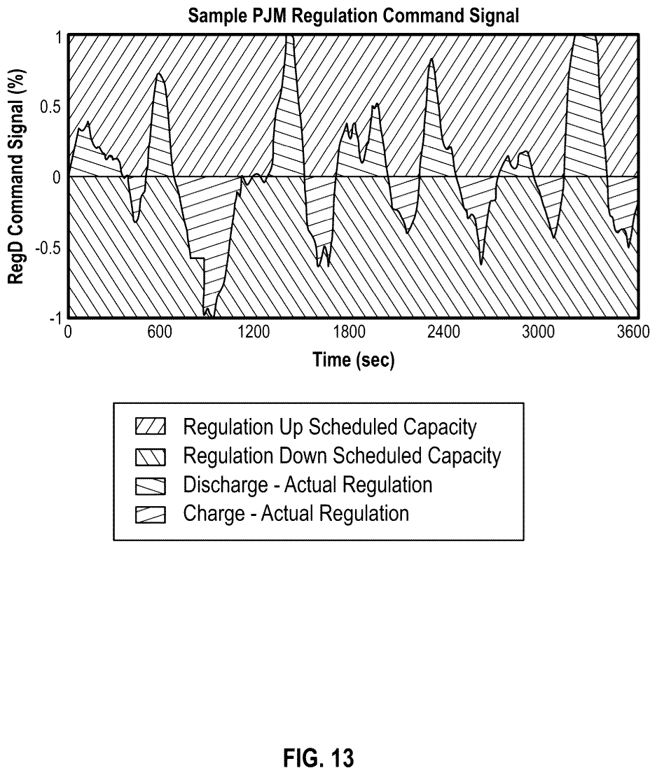

A weight moving through an oil or gas well may need to be controlled on a tight feedback loop in order to maximize value of the energy storage resource and minimize risk. Energy storage offers a variety of services to the grid. Frequency regulation is currently the most valuable service; and market structures include a “signal” that is provided to the energy storage operator, which includes a profile of discharge and charge rates that are requested to help the electrical grid maintain proper frequency. The more closely this signal is followed, the more valuable the storage resource is to the grid, and therefore the more it is compensated. FIG. 13 is a plot demonstrating how frequency regulation may occur when operating a gravity well system according to the present disclosure.

### Responsive Reserve Service (RRS)

Also referred to as a Spinning Reserve, this service may be actively synchronized to the grid and able to ramp up and/or down over a specified range within about 10 minutes or less of a notification signal from the system operator. In some examples, the service may be sustained for about two hours.

### Non-Spinning Reserve Service (Non-Spin)

This service may be capable of being synchronized to the grid and ramping to a certain level within a specified time period (e.g., 10 minutes). In some examples, the service may be sustained for two hours.

### Excess Generation Offset Service (EGOS)

Utilities almost always have excess generation capacity online. This is because capacity is added in fixed steps. This service could take advantage of the excess capacity by supplying an interruptible load to the utility wherein the energy used is renumerated at a dramatically reduced rate.

### Remote Bus Real Power Regulation

Bulk electric system circuits have capacity limitations inherent with their equipment ratings. The network of gravity wells can be coordinated to work as one entity in order to regulate power measured on a bus remote to each gravity well installation. The wells can charge or discharge in order to assist the grid in maintaining a specific output or ensuring that the power output at a given remote point does not exceed equipment or circuit ratings.

### Peak Shaving

The multiplicity of gravity wells can act together to capture and store excess generation created by intermittent power generating sources during non-peak demand hours. Later, when electrical demand rises, the captured energy can be released to meet peak demand conditions and balance grid loading conditions.

### Flexible Duration and Flexible Storage Term

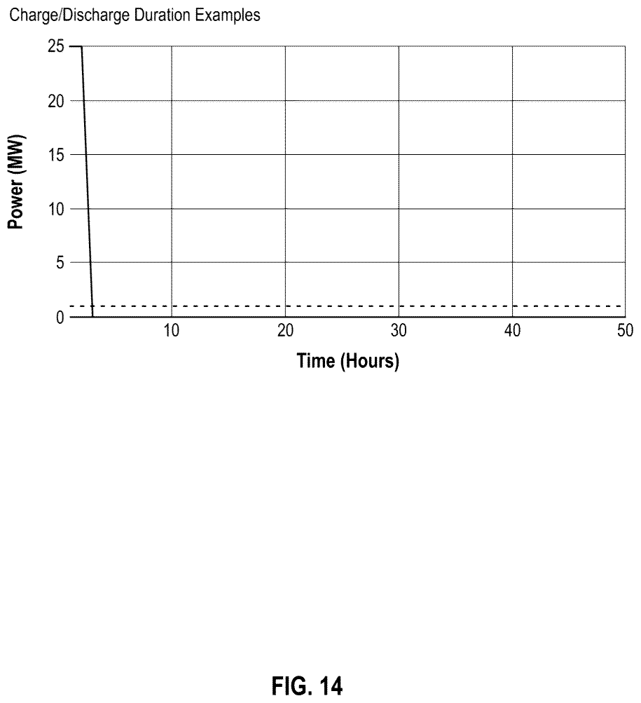

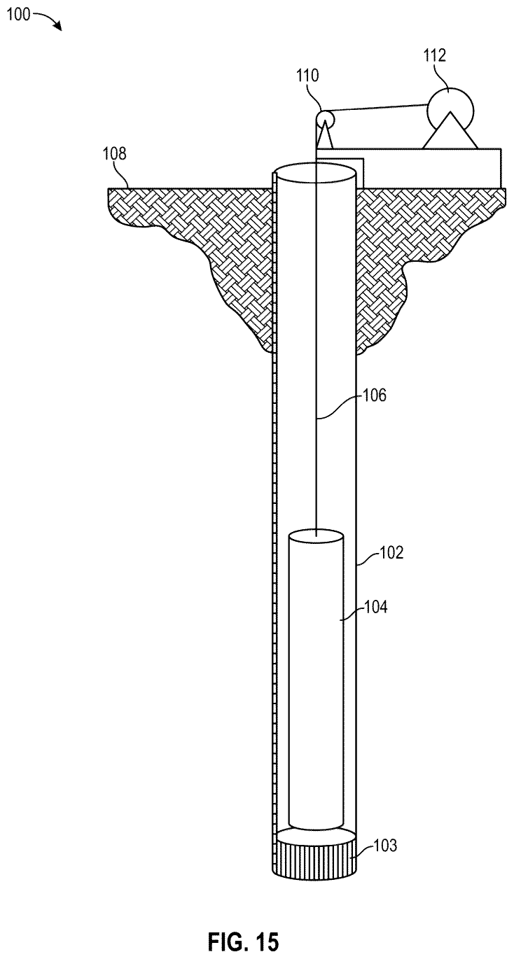

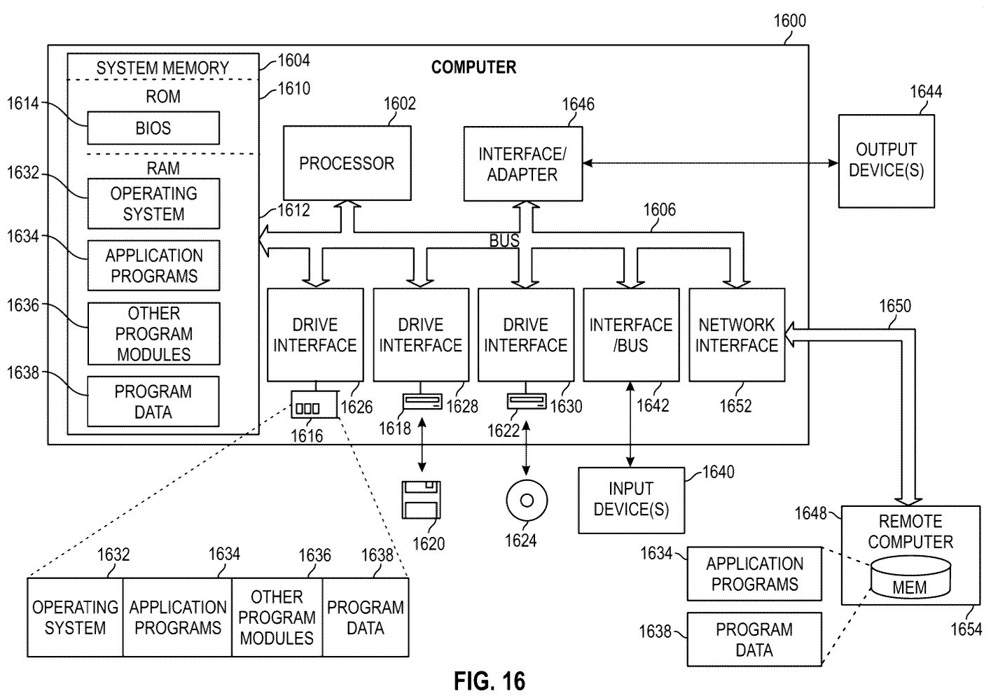

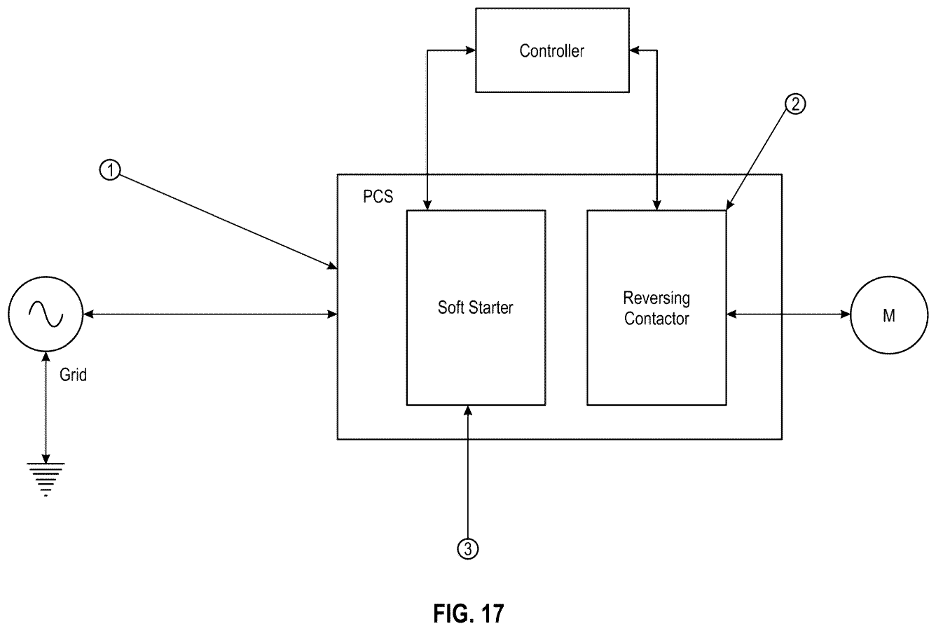

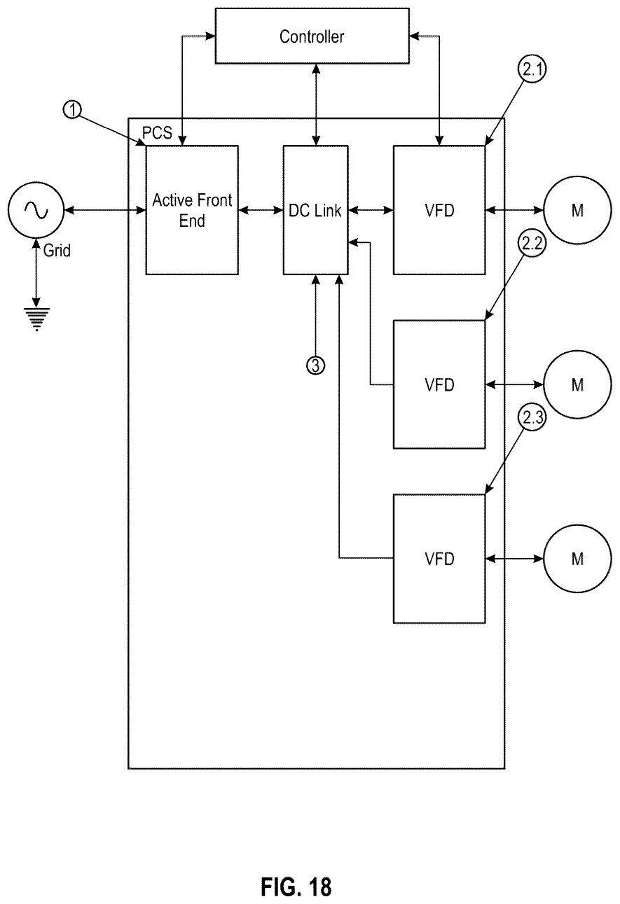

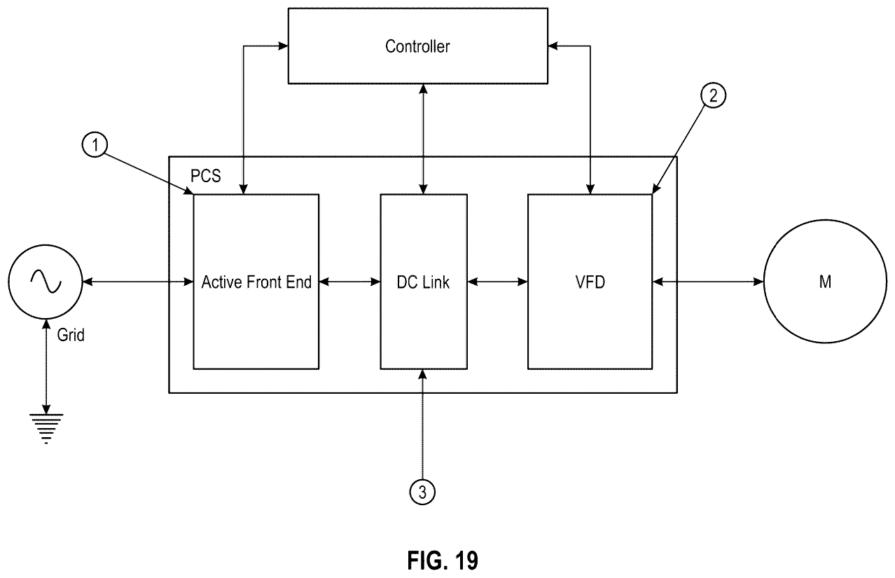

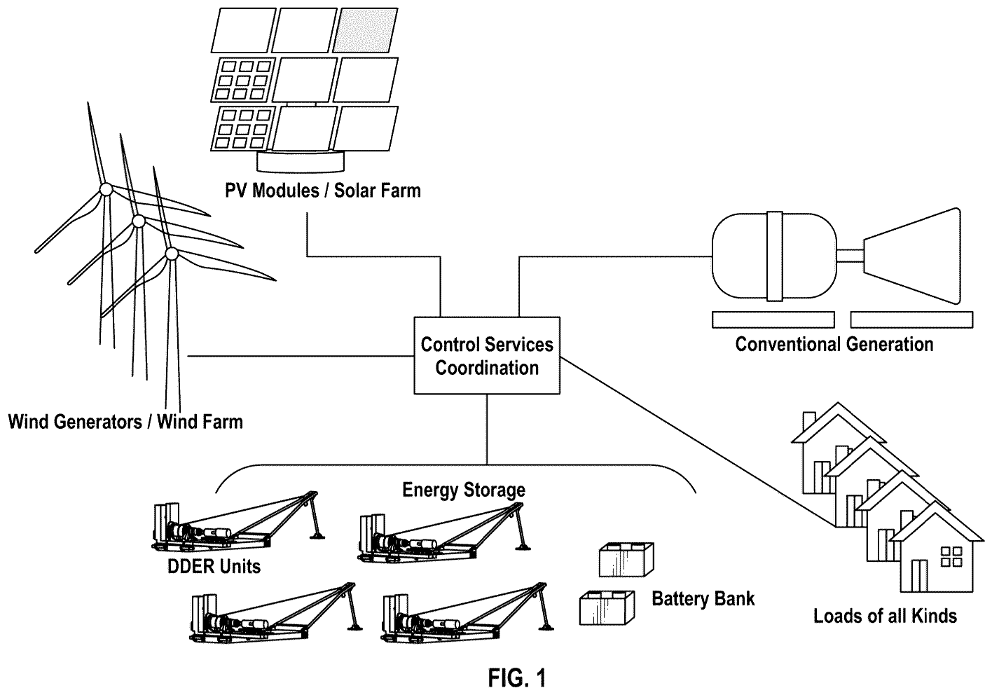

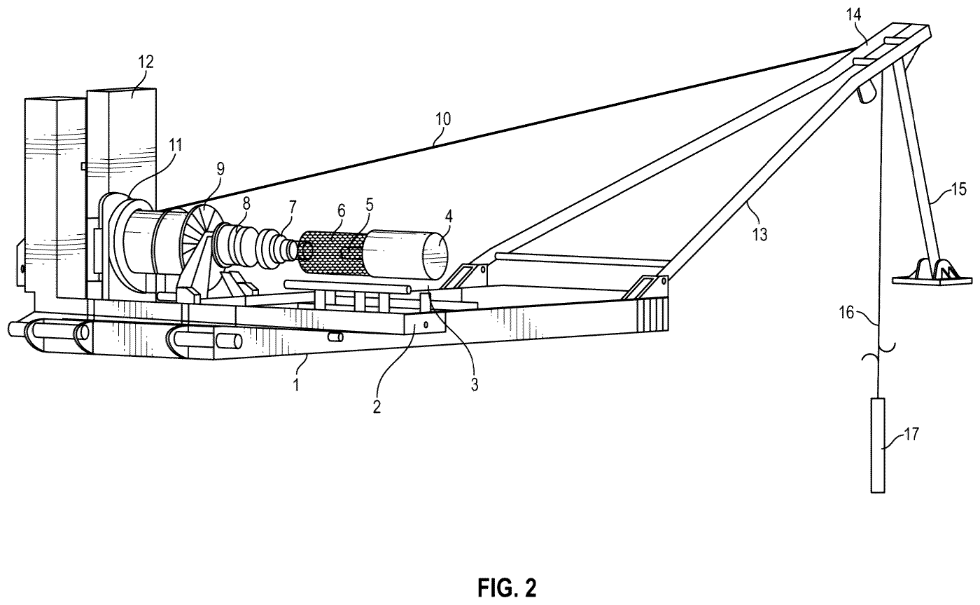

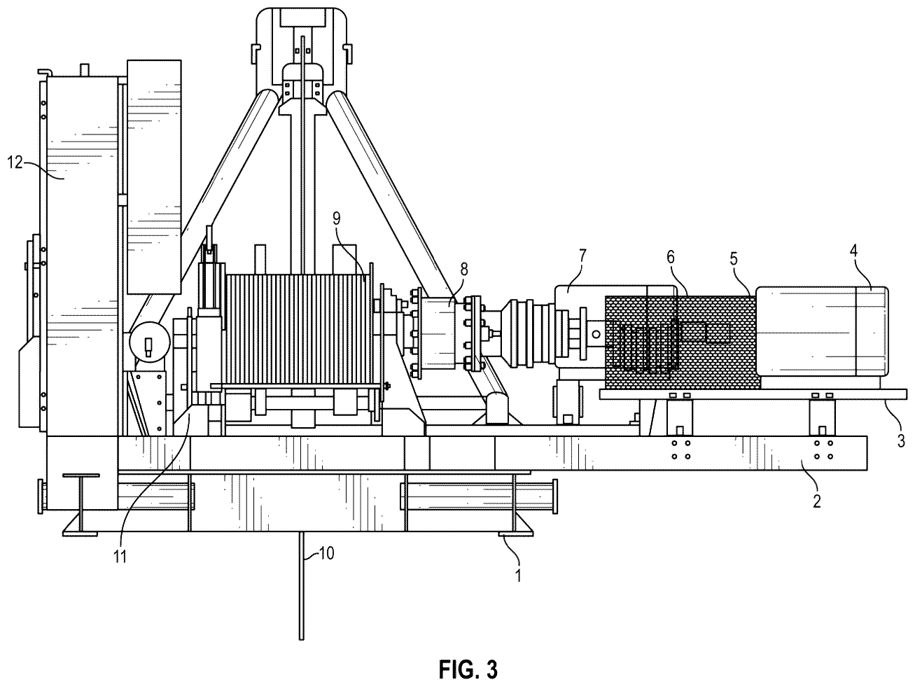

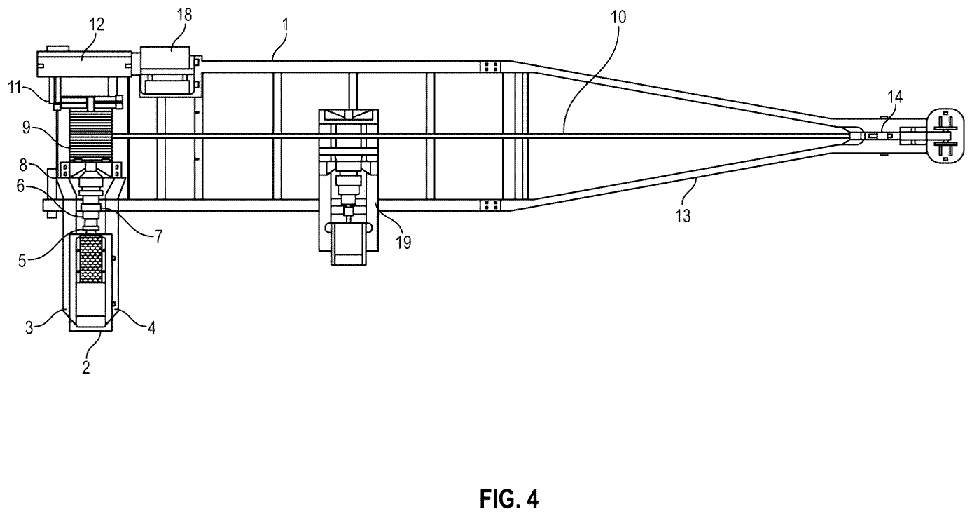

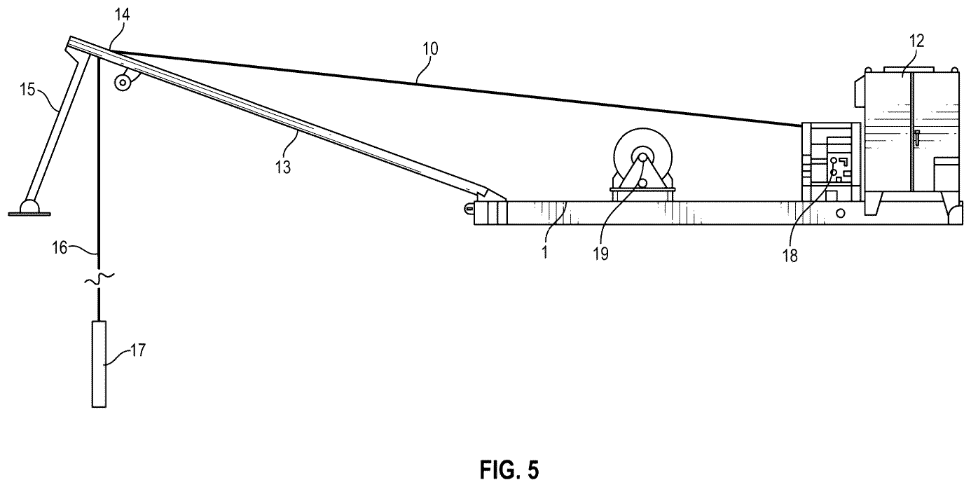

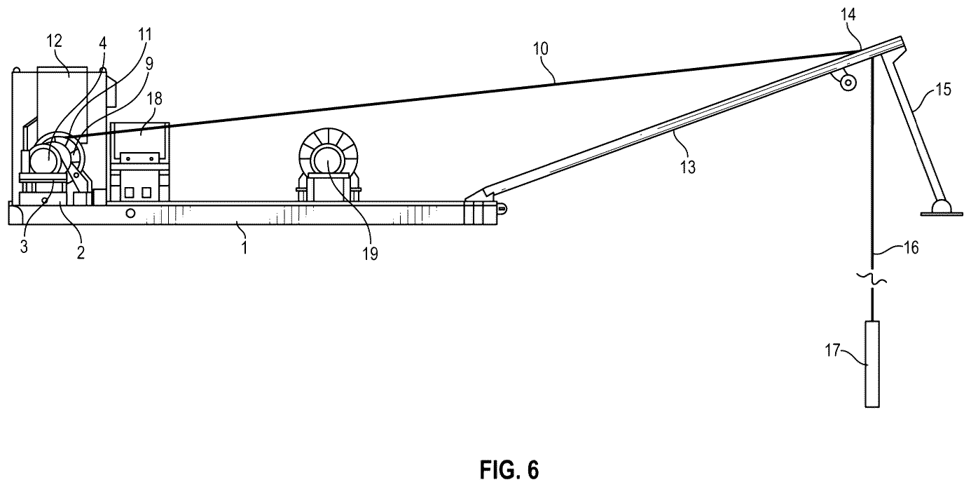

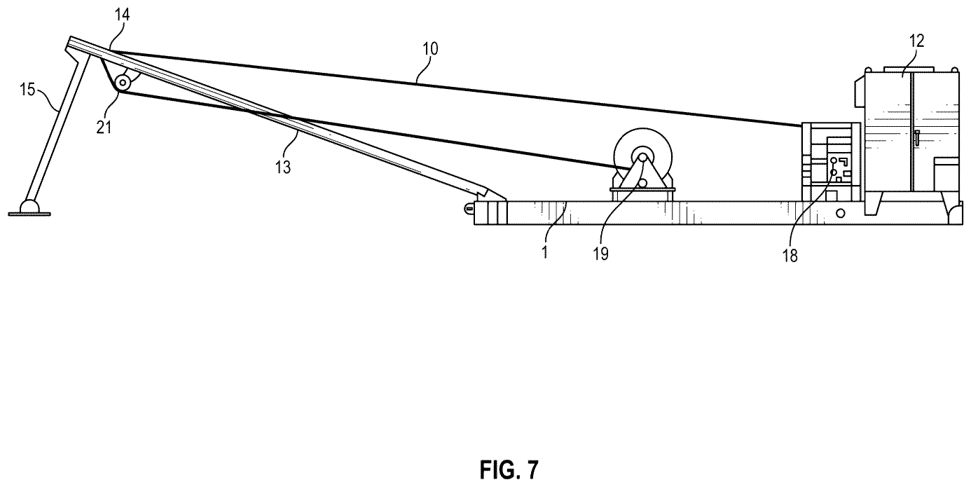

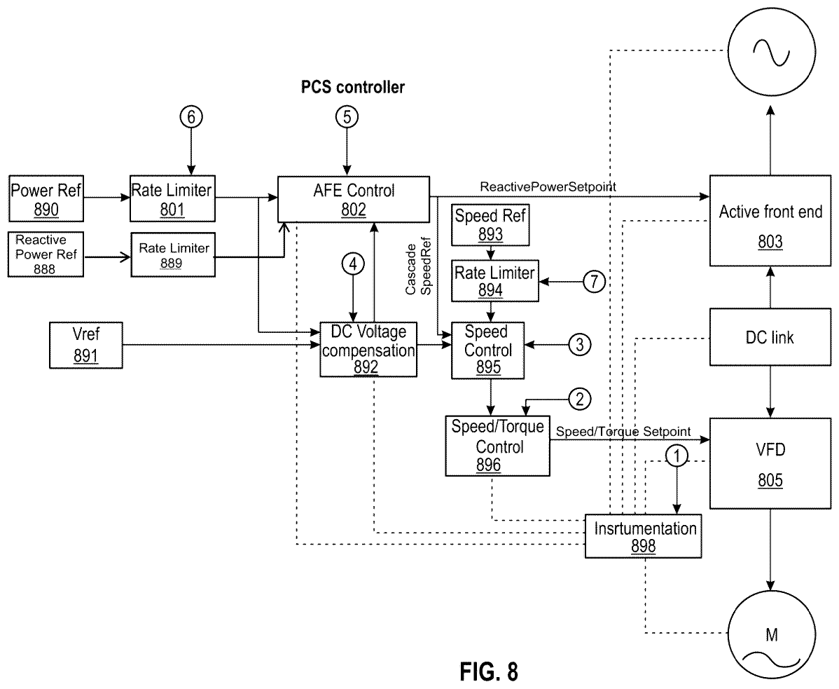

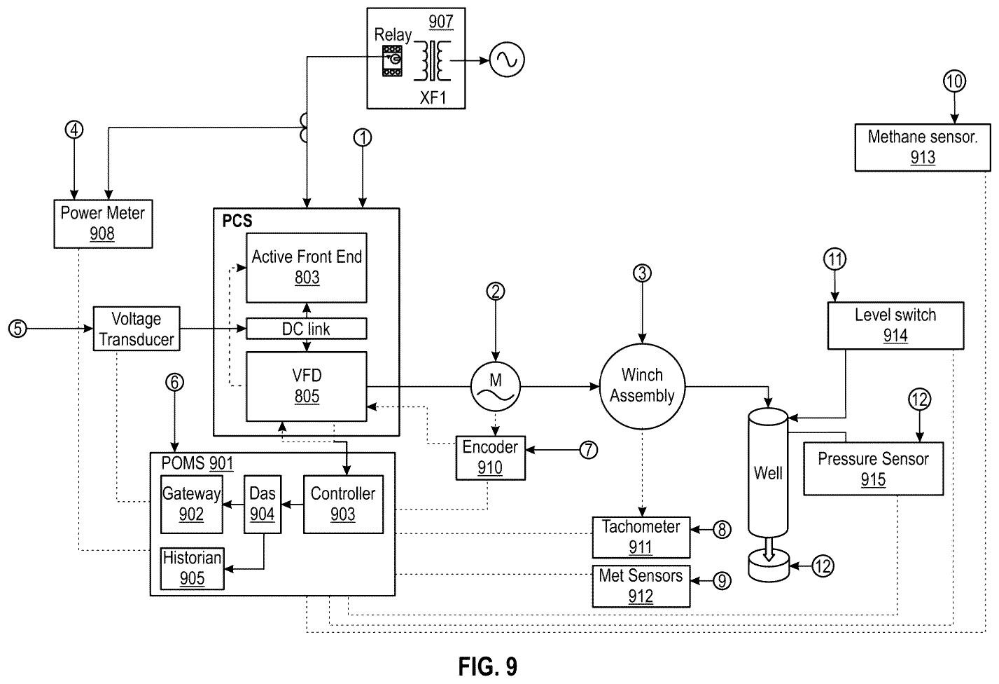

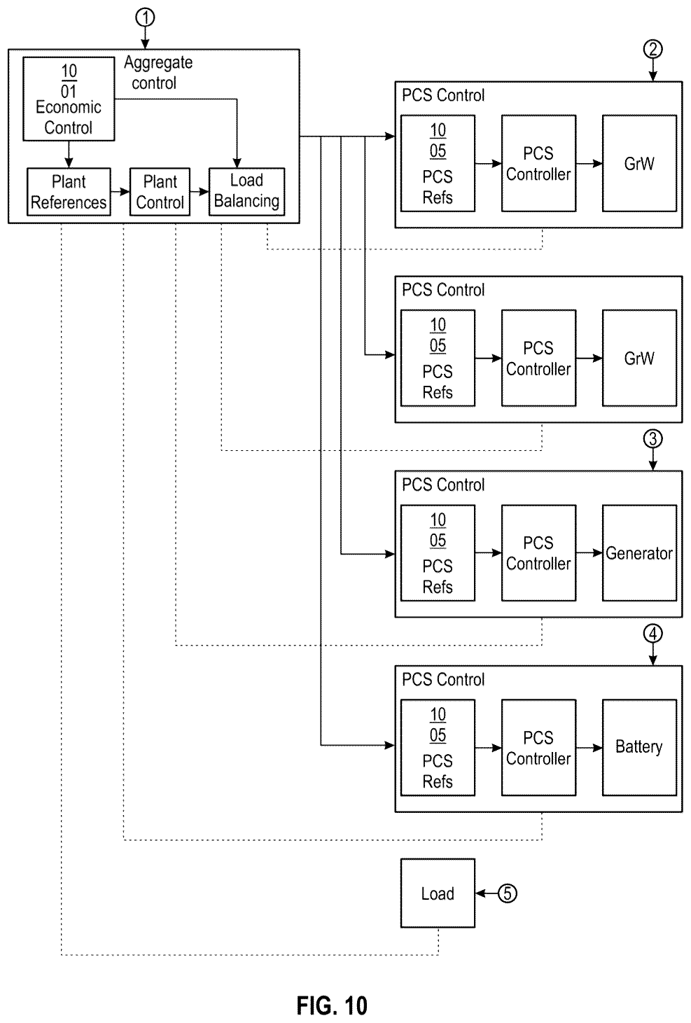

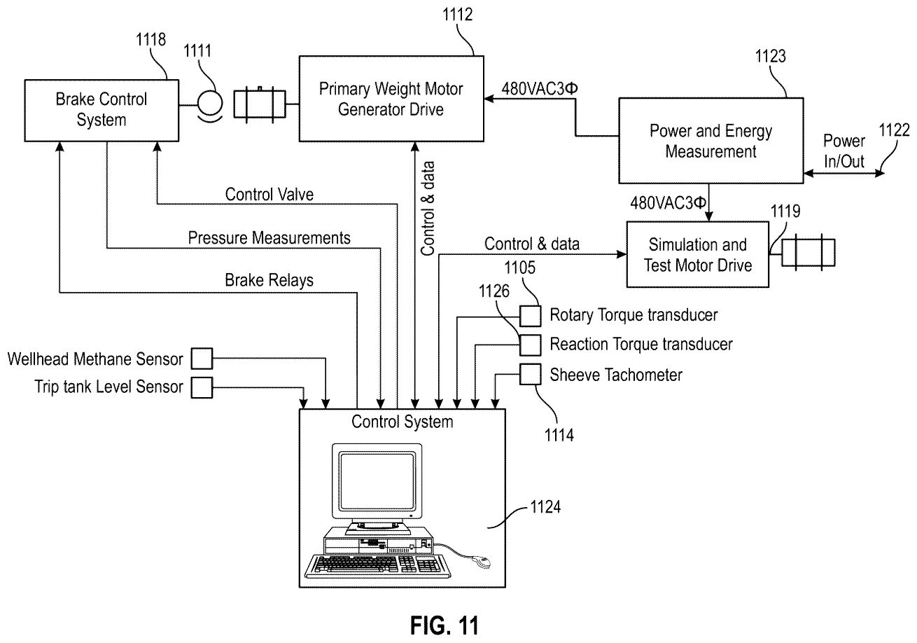

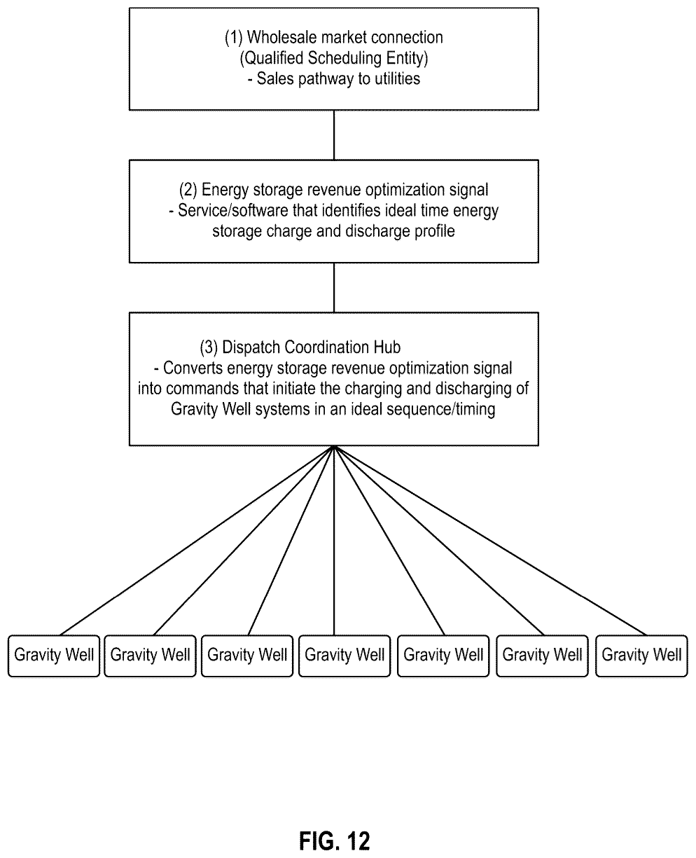

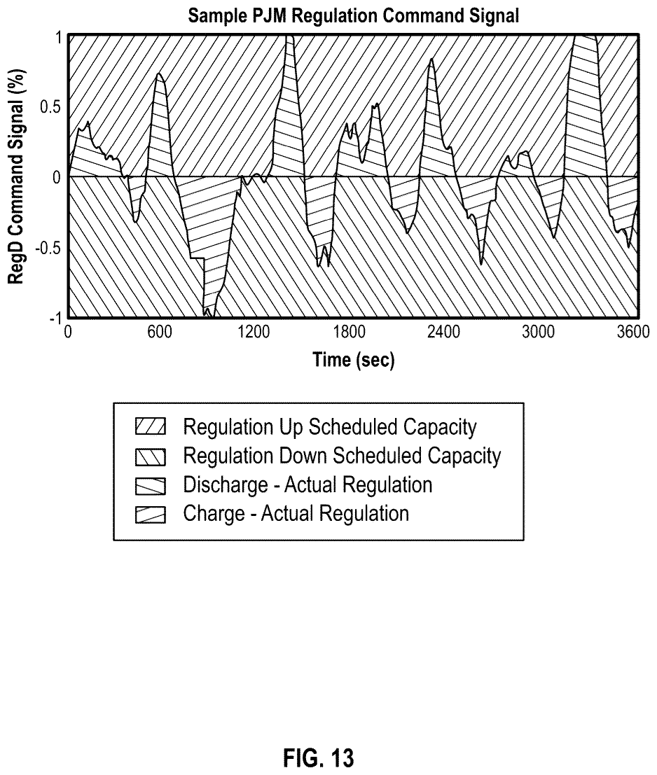

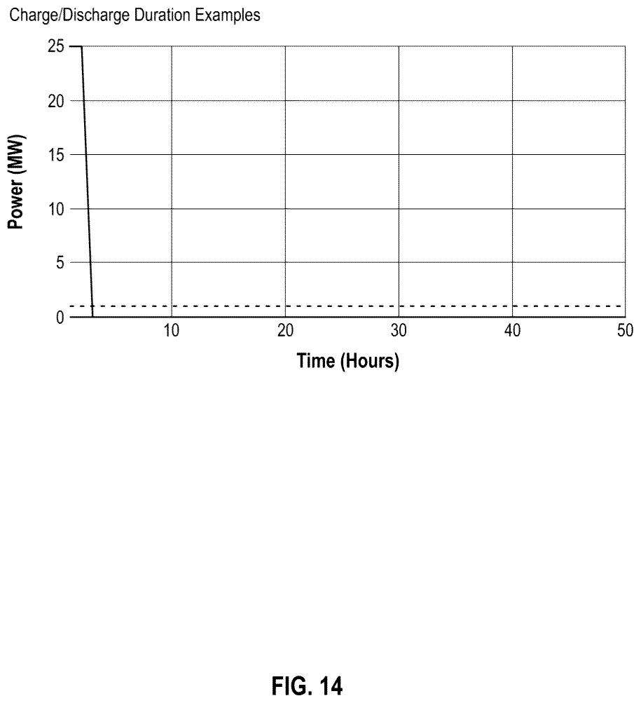

When deployed at scale, the gravity well system may be capable of operating in short duration, short-term energy storage markets, as well as long-duration, long-term energy storage markets. The control system may feature the means to convert the aggregated output of the gravity well energy storage systems to either operating scheme in order to maximize profit. This change may involve a change in the dispatch sequencing of the wells (fewer wells dispatched at a time may provide a longer duration charge or discharge sequence across a fleet of gravity well energy storage devices). FIG. 14 is a diagram showing two options that are examples of how the same well installation containing about 500 wells could discharge in a short duration (represented by the solid line) at a high power output, or for a long duration (represented by the dotted line) at a much lower power output. Further details on the gravity well systems that comprise this aggregated output are provided in the Table 1 below.

TABLE 1

| | Value | Units |
|---|---|---|
| Total Energy Storage | 50 | MWh |
| Gravity Well Systems | 500 | |
| System size | 0.1 | MWh |
| Gravity Well Duration | 1 | hr |
| (individual) | | |

In Aggregate

| | Long Duration | Short Duration |
|---|---|---|
| # Concurrently Dispatched | 10 | 250 |

In view of the foregoing structural and functional description, those skilled in the art will appreciate that portions of the embodiments may be embodied as a method, data processing system, or computer program product that operated in conjunction with the control systems described herein. Accordingly, these portions of the present embodiments may take the form of an entirely hardware embodiment, an entirely software embodiment, or an embodiment combining software and hardware, such as shown and described with respect to the computer system of FIG. 11 (e.g., as part of control system 24 of FIG. 11). Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such as, for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, non-volatile, or a combination of volatile and non-volatile, as appropriate.

Certain embodiments have also been described herein with reference to block illustrations of control systems. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 16 illustrates one example of a computer system 1600 that can be employed to execute one or more embodiments of the present disclosure. Computer system 1600 can be implemented on one or more general purpose networked control systems, computer systems, embedded computer systems, routers, switches, server devices, client devices, various intermediate devices/nodes or standalone computer systems. Additionally, computer system 1600 can be implemented on various mobile clients such as, for example, a personal digital assistant (PDA), laptop computer, pager, and the like, provided it includes sufficient processing capabilities.

Computer system 1600 includes processing unit 1602, system memory 1604, and system bus 1606 that couples various system components, including the system memory 1604, to processing unit 1602. System memory 1604 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 1602. System bus 1606 may be any of several types of bus structure including a memory bus or memory controller, a peripheral bus, and a local bus using any of a variety of bus architectures. System memory 1604 includes read only memory (ROM) 1610 and random access memory (RAM) 1612. A basic input/output system (BIOS) 1614 can reside in ROM 1610 containing the basic routines that help to transfer information among elements within computer system 1600.

Computer system 1600 can include a hard disk drive 1616, magnetic disk drive 1618, e.g., to read from or write to removable disk 1620, and an optical disk drive 1622, e.g., for reading CD-ROM disk 1624 or to read from or write to other optical media. Hard disk drive 1616, magnetic disk drive 1618, and optical disk drive 1622 are connected to system bus 1606 by a hard disk drive interface 1626, a magnetic disk drive interface 1628, and an optical drive interface 1630, respectively. The drives and associated computer-readable media provide nonvolatile storage of data, data structures, and computer-executable instructions for computer system 1600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

Computer system 1600 may operate in a networked environment using logical connections to one or more remote computers, such as remote computer 1648. Remote computer 1648 may be a workstation, computer system, router, peer device, or other common network node, and typically includes many or all of the elements described relative to computer system 1600. The logical connections, schematically indicated at 1650, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1600 can be connected to the local network through a network interface or adapter 1652. When used in a WAN networking environment, computer system 1600 can include a modem, or can be connected to a communications server on the LAN. The modem, which may be internal or external, can be connected to system bus 1606 via an appropriate port interface. In a networked environment, application programs 1634 or program data 1638 depicted relative to computer system 1600, or portions thereof, may be stored in a remote memory storage device 1654.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

Embodiments disclosed herein include:
A. Control systems for a gravity well. The systems comprise: an active front end (AFE) controller configured to receive a plurality of reference signals and a plurality of target control parameters, the plurality of reference signals comprising at least one of a power reference and a voltage reference (V_{ref}); a rate limiter coupled to the AFE controller and configured to adjust a rate of change associated with each of the plurality of target control parameters based, at least in part, on the plurality of reference signals; a speed control loop coupled to the AFE controller and configured to communicate with a variable-frequency drive (VFD), the VFD configured to store the plurality of target control parameters; and an AFE component coupled to the AFE controller and configured to communicate with a grid based on the plurality of target control parameters.
B. Control systems for a gravity well. The systems comprise: a controller; a plurality of sensors coupled to the controller; and a power control system (PCS) coupled to the controller, the PCS comprising: an active front end (AFE) component configured to communicate with a grid based, at least in part, on a plurality of target control parameters and a plurality of reference signals, the plurality of target control parameters and the plurality of reference signals generated based on signals from the plurality of sensors; and a variable-frequency drive (VFD) and configured to store the plurality of target control parameters.
C. Methods for controlling charge or discharge of a gravity well or gravity well system. The methods comprise: receiving, at an active front end (AFE) controller, a plurality of reference signals and a plurality of target control parameters, the plurality of reference signals comprising at least one of a power reference, a speed reference, and a voltage reference (Vref); adjusting, based at least in part on the plurality of reference signals, a rate of change associated with each of the plurality of target control parameters; storing, at a variable-frequency drive (VFD), the plurality of target control parameters; and communicating with a grid based on the plurality of target control parameters.

Each of A-C may have one or more of the following elements or a combination thereof.
Element 1: wherein the plurality of target control parameters comprises at least one of one or more quadrature current vectors, a DC link voltage, one or more target discharge rates, one or more target velocities, and one or more target torque values.
Element 2: wherein the AFE component is configured to receive or generate at least one of one or more reactive power signals and the VFD is configured to receive one or more speed set point signals.
Element 3: wherein the AFE component feeds the one or more reactive power signals.
Element 4: wherein the speed control loop further comprises: a second optional rate limiter configured to receive a speed reference signal and adjust a speed value; a speed control component configured to receive the speed reference signal and adjust the speed value; a DC voltage compensation component configured to receive the plurality of reference signals; and a torque controller configured to process the speed value and a torque value.
Element 5: wherein the speed control loop is configured to adjust, based at least in part on instrumentation information, a speed value and a torque value.
Element 6: wherein Vref calibrates the AFE component to utilize multiple gravity energy storage devices operating in parallel at the grid.
Element 7: wherein the plurality of sensors includes at least one of a methane sensor, a level sensor, pressure sensor, a tachometer, and a meteorological sensor.
Element 8: wherein the plurality of reference signals comprise at least one of a power reference and a voltage reference (Vref).
Element 9: wherein the plurality of target control parameters comprises at least one of one or more quadrature current vectors, a DC link voltage, one or more target discharge rates, one or more target velocities, and one or more target torque values.
Element 10: wherein the method further comprises receiving or generating at least one of one or more reactive power signals and one or more speed set point signals.
Element 11: wherein the method further comprises feeding the one or more reactive power signals, the one or more speed set point signals, or both to a speed control loop.
Element 12: wherein the method further comprises receiving the speed reference signal at the speed control loop; receiving the Vref at the speed control loop; and adjusting a speed value and a torque value.
Element 13: wherein the method further comprises adjusting, based at least in part on instrumentation information, a speed value and a torque value.

Additional embodiments disclosed herein include:

Embodiment 1. A control system for a gravity well, comprising:
an active front end (AFE) controller configured to receive a plurality of reference signals and a plurality of target control parameters, the plurality of reference signals comprising at least one of a power reference and a voltage reference (Vref);
a rate limiter coupled to the AFE controller and configured to adjust a rate of change associated with each of the plurality of target control parameters based, at least in part, on the plurality of reference signals;
a speed control loop coupled to the AFE controller and configured to communicate with a variable-frequency drive (VFD), the VFD configured to store the plurality of target control parameters; and
an AFE component coupled to the AFE controller and configured to communicate with a grid based on the plurality of target control parameters.

Embodiment 2. The control system of Embodiment 1, wherein the plurality of target control parameters comprises at least one of one or more quadrature current vectors, a DC link voltage, one or more target discharge rates, one or more target velocities, and one or more target torque values.

Embodiment 3. The control system of Embodiment 1 or Embodiment 2, wherein the AFE component is configured to receive or generate at least one of one or more reactive power signals and the VFD is configured to receive one or more speed set point signals.

Embodiment 4. The control system of Embodiment 3, wherein the AFE component feeds the one or more reactive power signals.

Embodiment 5. The control system of any one of Embodiments 1-4, wherein the speed control loop further comprises:
a second optional rate limiter configured to receive a speed reference signal and adjust a speed value;
a speed control component configured to receive the speed reference signal and adjust the speed value;
a DC voltage compensation component configured to receive the plurality of reference signals; and
a torque controller configured to process the speed value and a torque value.

Embodiment 6. The control system of any one of Embodiments 1-5, wherein the speed control loop is configured to adjust, based at least in part on instrumentation information, a speed value and a torque value.

Embodiment 7. The control system of any one of Embodiments 1-6, wherein Vref calibrates the AFE component to utilize multiple gravity energy storage devices operating in parallel at the grid.

Embodiment 8. A control system for a gravity well, comprising:
a controller;
a plurality of sensors coupled to the controller; and
a power control system (PCS) coupled to the controller, the PCS comprising:
   an active front end (AFE) component configured to communicate with a grid based, at least in part, on a plurality of target control parameters and a plurality of reference signals, the plurality of target control parameters and the plurality of reference signals generated based on signals from the plurality of sensors; and
   a variable-frequency drive (VFD) and configured to store the plurality of target control parameters.

Embodiment 9. The control system of Embodiment 8, wherein the plurality of sensors includes at least one of a methane sensor, a level sensor, pressure sensor, a tachometer, and a meteorological sensor.

Embodiment 10. The control system of Embodiment 8 or Embodiment 9, wherein the plurality of reference signals comprise at least one of a power reference and a voltage reference (Vref)

Embodiment 11. The control system of any one of Embodiments 8-10, wherein Vref Calibrates the AFE component to utilize multiple gravity energy storage devices operating in parallel at the grid.

Embodiment 12. The control system of any one of Embodiments 8-11, wherein the plurality of target control parameters comprises at least one of one or more quadrature current vectors, a DC link voltage, one or more target discharge rates, one or more target velocities, and one or more target torque values.

Embodiment 13. The control system of any one of Embodiments 8-12, wherein the AFE component is configured to receive or generate at least one of one or more reactive power signals and the VFD is configured to receive one or more speed set point signals.

Embodiment 14. A method for controlling charge or discharge of a gravity well or gravity well system, comprising:

receiving, at an active front end (AFE) controller, a plurality of reference signals and a plurality of target control parameters, the plurality of reference signals comprising at least one of a power reference, a speed reference, and a voltage reference (Vref);
adjusting, based at least in part on the plurality of reference signals, a rate of change associated with each of the plurality of target control parameters;
storing, at a variable-frequency drive (VFD), the plurality of target control parameters; and
communicating with a grid based on the plurality of target control parameters.

Embodiment 15. The method of Embodiment 14, wherein the plurality of target control parameters comprises at least one of one or more quadrature current vectors, a DC link voltage, one or more target discharge rates, one or more target velocities, and one or more target torque values.

Embodiment 16. The method of Embodiment 14 or Embodiment 15, further comprising: receiving or generating at least one of one or more reactive power signals and one or more speed set point signals.

Embodiment 17. The method of Embodiment 16, further comprising:
feeding the one or more reactive power signals, the one or more speed set point signals, or both to a speed control loop.

Embodiment 18. The method of Embodiment 17, further comprising:
receiving the speed reference signal at the speed control loop;
receiving the V_{ref} at the speed control loop; and
adjusting a speed value and a torque value.

Embodiment 19. The method of Embodiment 17 or Embodiment 18, further comprising:
adjusting, based at least in part on instrumentation information, a speed value and a torque value.

Embodiment 20. The method of any one of Embodiments 14-19, wherein V_{ref} calibrates the AFE component to utilize multiple gravity energy storage devices operating in parallel at the grid.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A control system for a gravity well, comprising:
an active front end (AFE) controller configured to receive a plurality of reference signals and a plurality of target control parameters, the plurality of reference signals comprising at least one of a power reference and a voltage reference (V_{ref});
a rate limiter coupled to the AFE controller and configured to adjust a rate of change associated with each of the plurality of target control parameters based, at least in part, on the plurality of reference signals;
a speed control loop coupled to the AFE controller and configured to communicate with a variable-frequency drive (VFD), the VFD configured to store the plurality of target control parameters; and
an AFE component coupled to the AFE controller and configured to communicate with a grid based on the plurality of target control parameters.

2. The control system of claim 1, wherein the plurality of target control parameters comprises at least one of one or more quadrature current vectors, a DC link voltage, one or more target discharge rates, one or more target velocities, and one or more target torque values.

3. The control system of claim 1, wherein the AFE component is configured to receive or generate at least one of one or more reactive power signals and the VFD is configured to receive one or more speed set point signals.

4. The control system of claim 3, wherein the AFE component feeds the one or more reactive power signals.

5. The control system of claim 1, wherein the speed control loop further comprises:
a second optional rate limiter configured to receive a speed reference signal and adjust a speed value;
a speed control component configured to receive the speed reference signal and adjust the speed value;
a DC voltage compensation component configured to receive the plurality of reference signals; and
a torque controller configured to process the speed value and a torque value.

6. The control system of claim 1, wherein the speed control loop is configured to adjust, based at least in part on instrumentation information, a speed value and a torque value.

7. The control system of claim 1, wherein V_{ref} calibrates the AFE component to utilize multiple gravity energy storage devices operating in parallel at the grid.

8. A control system for a gravity well, comprising:
a controller;
a plurality of sensors coupled to the controller; and
a power control system (PCS) coupled to the controller, the PCS comprising:
an active front end (AFE) component configured to communicate with a grid based, at least in part, on a plurality of target control parameters and a plurality of reference signals, the plurality of target control parameters and the plurality of reference signals generated based on signals from the plurality of sensors; and
a variable-frequency drive (VFD) and configured to store the plurality of target control parameters.

9. The control system of claim 8, wherein the plurality of sensors includes at least one of a methane sensor, a level sensor, pressure sensor, a tachometer, and a meteorological sensor.

10. The control system of claim 8, wherein the plurality of reference signals comprise at least one of a power reference and a voltage reference (V_{ref}).

11. The control system of claim 8, wherein V_{ref} calibrates the AFE component to utilize multiple gravity energy storage devices operating in parallel at the grid.

12. The control system of claim 8, wherein the plurality of target control parameters comprises at least one of one or more quadrature current vectors, a DC link voltage, one or more target discharge rates, one or more target velocities, and one or more target torque values.

13. The control system of claim 8, wherein the AFE component is configured to receive or generate at least one of one or more reactive power signals and the VFD is configured to receive one or more speed set point signals.

14. A method for controlling charge or discharge of a gravity well or gravity well system, comprising:
receiving, at an active front end (AFE) controller, a plurality of reference signals and a plurality of target control parameters, the plurality of reference signals comprising at least one of a power reference, a speed reference, and a voltage reference (V_{ref});
adjusting, based at least in part on the plurality of reference signals, a rate of change associated with each of the plurality of target control parameters;
storing, at a variable-frequency drive (VFD), the plurality of target control parameters; and
communicating with a grid based on the plurality of target control parameters.

15. The method of claim 14, wherein the plurality of target control parameters comprises at least one of one or more quadrature current vectors, a DC link voltage, one or more target discharge rates, one or more target velocities, and one or more target torque values.

16. The method of claim 14, further comprising: receiving or generating at least one of one or more reactive power signals and one or more speed set point signals.

17. The method of claim 16, further comprising:
feeding the one or more reactive power signals, the one or more speed set point signals, or both to a speed control loop.

18. The method of claim 17, further comprising:
receiving the speed reference signal at the speed control loop;
receiving the V_{ref} at the speed control loop; and
adjusting a speed value and a torque value.

19. The method of claim 17, further comprising:
adjusting, based at least in part on instrumentation information, a speed value and a torque value.

20. The method of claim 14, wherein V_{ref} calibrates the AFE component to utilize multiple gravity energy storage devices operating in parallel at the grid.
